(19) United States
(12) Patent Application Publication
(10) Pub. No.: US 2026/0353288 A1
(43) Pub. Date: Nov. 5, 2026

(54) METHODS, DEVICES, AND MEDIUM FOR COMMUNICATION

(71) Applicant: NEC Corporation, Tokyo (JP)

(72) Inventors: Lei CHEN, Beijing (CN); Gang WANG, Beijing (CN)

(73) Assignee: NEC Corporation, Tokyo (JP)

(21) Appl. No.: 19/124,482

(22) PCT Filed: Oct. 27, 2022
(86) PCT No.: PCT/CN2022/128031

§ 371 Date: Apr. 25, 2025

(51) Int. Cl. H04W 52/02; H04W 68/02; H04W 76/28

(52) U.S. Cl. CPC H04W 52/0235; H04W 68/02; H04W 76/28

(57) ABSTRACT

Example embodiments of the present disclosure relate to methods, devices, and computer storage medium for communication. A terminal device receives a configuration from a network device; determines whether an LP-WUS is configured or activated based on the configuration; if the LP-WUS is configured or activated, determines multiple POS/PEI-Os in at least one DRX cycle; if a positive LP-WUS is detected in a WO, determines, from the multiple target POs/PEI-Os, at least one target PO/PEI-O associated with the WO; and monitors the at least one target PO/PEI-O. Since the association between the WO and the PO/PEI-O is used, there is no need to wait for a long time before monitoring the PO/PEI-O, and a low latency can be achieved. Therefore, power consumption may be further reduced at the terminal device and the efficiency of the communication may be improved.

### FIELD

Example embodiments of the present disclosure generally relate to the field of communication techniques and in particular, to methods, devices, and a computer readable medium for communication.

### BACKGROUND

Several technologies have been proposed for power saving of a terminal device. For example, a user equipment (UE) may enter to a radio resource control (RRC) idle/inactive state to reduce power consumption. However, it is still critical for power limited devices, e.g., the Internet of Things (IoT) devices, wearable devices, etc., since periodic paging monitoring and measurement consume considerable power at UE side even in RRC idle/inactive state. Therefore, it is beneficial for UE to further reduce the power consumption.

### SUMMARY

In general, example embodiments of the present disclosure provide methods, devices and a computer storage medium for communication.

In a first aspect, there is provided a method of communication. The method comprises: receiving, at a terminal device, a configuration from a network device; determining whether a low power wake up signal (LP-WUS) is configured or activated based on the configuration; in accordance with a determination that the LP-WUS is configured or activated, determining a plurality of target paging occasions (POs) or paging early indication occasions (PEI-Os) in at least one discontinuous reception (DRX) cycle; in accordance with a determination that a positive LP-WUS is detected in a wake up occasion (WO), determining, from the plurality of target POs or PEI-Os, at least one target PO or PEI-O associated with the WO; and monitoring the at least one target PO or PEI-O.

In a second aspect, there is provided a method of communication. The method comprises: receiving, at a terminal device, a low power wake up signal (LP-WUS) configuration from a network device; determining a plurality of wake-up occasions (WOs) based on the LP-WUS configuration; monitoring the plurality of WOs; in accordance with a determination that a positive LP-WUS is detected in one of the plurality of WOs, determining at least one target paging occasion (PO) or paging early indication occasion (PEI-O) based on a time offset configured by the network device and a first time at which the positive LP-WUS is detected; and monitoring the at least one target PO or PEI-O.

In a third aspect, there is provided a method of communication. The method comprises: receiving, at a terminal device from a network device, a first paging configuration and a second paging configuration, the first paging configuration indicating a denser paging occasion (PO) or paging early indication occasion (PEI-O) than the second paging configuration; determining a first set of POs or PEI-Os based on the first paging configuration; determining a second set of POs or PEI-Os based on the second paging configuration; in accordance with a determination that a low power wake up signal (LP-WUS) is configured or activated, monitoring the first set of POs or PEI-Os; and in accordance with a determination that at least one of the following conditions is met, starting to monitor the second set of POs or PEI-Os: the terminal device is out of a coverage of the LP-WUS, a signal quality of the LP-WUS is equal to or lower than a quality threshold, a first indication indicates the terminal device to start to monitor based on the second paging configuration is received from the network device, a second indication from the network device indicates the terminal device to stop monitoring based on the first paging configuration is received from the network device, a third indication from the network device indicates the terminal device to quit a deep sleeping mode is received from the network device, or a fourth indication from the network device indicates that the LP-WUS is deactivated is received from the network device.

In a fourth aspect, there is provided a method of communication. The method comprises: transmitting, at a network device to a terminal device, a configuration indicating that a low power wake up signal (LP-WUS) is configured or activated; determining a plurality of target paging occasions (POs) or paging early indication occasions (PEI-Os) for the terminal device in at least one discontinuous reception (DRX) cycle; transmitting, to the terminal device, a positive LP-WUS in a wake up occasion (WO); determining at least one target PO or PEI-O associated with the WO from the plurality of target POs or PEI-Os; and transmitting, to the terminal device, paging downlink control information (DCI) in one of the at least one target PO or a paging early indication (PEI) in one of the at least one target PEI-O.

In a fifth aspect, there is provided a method of communication. The method comprises: transmitting, at a network device to a terminal device, a low power wake up signal (LP-WUS) configuration indicating a plurality of wake-up occasions (WOs); transmitting a positive LP-WUS in one of the plurality of WOs; determining at least one target paging occasion (PO) or paging early indication occasion (PEI-O) based on a time offset and a first time at which the positive LP-WUS is transmitted; and transmitting, to the terminal device, paging downlink control information (DCI) in one of the at least one target PO or a paging early indication (PEI) in one of the at least one target PEI-O.

In a sixth aspect, there is provided a terminal device. The terminal device comprises a processor and a memory. The memory is coupled to the processor and stores instructions thereon. The instructions, when executed by the processor, cause the terminal device to perform the method according to any one of the first to the third aspects above.

In a seventh aspect, there is provided a network device. The network device comprises a processor and a memory. The memory is coupled to the processor and stores instructions thereon. The instructions, when executed by the processor, cause the network device to perform the method according to the fourth or fifth aspect above.

In an eighth aspect, there is provided a computer readable medium having instructions stored thereon, the instructions, when executed on at least one processor, causing the at least one processor to carry out the method according to any one of the first to the fifth aspects above.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Through the more detailed description of some example embodiments of the present disclosure in the accompanying drawings, the above and other objects, features and advantages of the present disclosure will become more apparent, wherein:

FIG. 1 illustrates an example communication system in which some embodiments of the present disclosure can be implemented;

FIG. 2A illustrates a schematic diagram of resources occupied by an LP signal which can be used in some example embodiments of the present disclosure;

FIGS. 2B-2C illustrate schematic diagrams of OOK symbols which can be used in some example embodiments of the present disclosure;

FIG. 3 illustrates a signalling chart illustrating communication process in accordance with some embodiments of the present disclosure;

FIG. 4 illustrates a schematic diagram of POs in a DRX cycle in accordance with some embodiments of the present disclosure;

FIG. 5 illustrates a schematic diagram of the first DRX cycle and the second DRX cycle in accordance with some embodiments of the present disclosure;

FIG. 6 illustrates a schematic diagram of the association between a WO and a group of POs in accordance with some embodiments of the present disclosure;

FIG. 7 illustrates a signalling chart illustrating communication process in accordance with some embodiments of the present disclosure;

FIG. 8 illustrates a schematic diagram of the association between a WO and a PO in accordance with some embodiments of the present disclosure;

FIG. 9 illustrates a signalling chart illustrating communication process in accordance with some embodiments of the present disclosure;

FIG. 10 illustrates a schematic diagram of the association between PFs in the first set of PFs and a PF in the second set of PFs accordance with some embodiments of the present disclosure;

FIG. 11 illustrates a flowchart of an example method in accordance with some embodiments of the present disclosure;

FIG. 12 illustrates a flowchart of an example method in accordance with some embodiments of the present disclosure;

FIG. 13 illustrates a flowchart of an example method in accordance with some embodiments of the present disclosure;

FIG. 14 illustrates a flowchart of an example method in accordance with some embodiments of the present disclosure;

FIG. 15 illustrates a flowchart of an example method in accordance with some embodiments of the present disclosure; and

FIG. 16 illustrates a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

In some examples, values, procedures, or apparatus are referred to as “best,” “lowest,” “highest,” “minimum,” “maximum,” or the like. It will be appreciated that such descriptions are intended to indicate that a selection among many used functional alternatives can be made, and such selections need not be better, smaller, higher, or otherwise preferable to other selections.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G), 5.5G, 5G-Advanced networks, or the sixth generation (6G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “terminal device” refers to any device having wireless or wired communication capabilities. Examples of terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Space borne vehicles or Air borne vehicles in Non-terrestrial networks (NTN) including Satellites and High Altitude Platforms (HAPs) encompassing Unmanned Aircraft Systems (UAS), extended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPV6 multicast delivery, IPTV, smart TV, radio services, software delivery over wireless, group communications and IoT applications. It may also be incorporated one or multiple Subscriber Identity Module (SIM) as known as Multi-SIM. The term “terminal device” can be used interchangeably with a UE, a mobile station, a subscriber station, a mobile terminal, a user terminal or a wireless device.

As used herein, the term “network device” refers to a device which is capable of providing or hosting a cell or coverage where terminal devices can communicate. Examples of a network device include, but not limited to, a satellite, a unmanned aerial systems (UAS) platform, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), and the like.

In one embodiment, the terminal device may be connected with a first network device and a second network device. One of the first network device and the second network device may be a master node and the other one may be a secondary node. The first network device and the second network device may use different radio access technologies (RATs). In one embodiment, the first network device may be a first RAT device and the second network device may be a second RAT device. In one embodiment, the first RAT device is eNB and the second RAT device is gNB. Information related with different RATs may be transmitted to the terminal device from at least one of the first network device and the second network device. In one embodiment, first information may be transmitted to the terminal device from the first network device and second information may be transmitted to the terminal device from the second network device directly or via the first network device. In one embodiment, information related with configuration for the terminal device configured by the second network device may be transmitted from the second network device via the first network device. Information related with reconfiguration for the terminal device configured by the second network device may be transmitted to the terminal device from the second network device directly or via the first network device.

Communications discussed herein may conform to any suitable standards including, but not limited to, New Radio Access (NR), Long Term Evolution (LTE), LTE-Evolution, LTE-Advanced (LTE-A), Wideband Code Division Multiple Access (WCDMA), Code Division Multiple Access (CDMA), cdma2000, and Global System for Mobile Communications (GSM) and the like. Furthermore, the communications may be performed according to any generation communication protocols either currently known or to be developed in the future. Examples of the communication protocols include, but not limited to, the first generation (1G), the second generation (2G), 2.5G, 2.85G, the third generation (3G), the fourth generation (4G), 4.5G, the fifth generation (5G), and the sixth (6G) communication protocols. The techniques described herein may be used for the wireless networks and radio technologies mentioned above as well as other wireless networks and radio technologies. The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

The terminal device or the network device may have Artificial intelligence (AI) or machine learning capability. It generally includes a model which has been trained from numerous collected data for a specific function, and can be used to predict some information.

The terminal device or the network device may work on several frequency ranges, e.g. FR1 (410 MHz-7125 MHz), FR2(24.25 GHz to 71GHz), frequency band larger than 100 GHz as well as Tera Hertz (THz). It can further work on licensed/unlicensed/shared spectrum. The terminal device may have more than one connection with the network device under Multi-Radio Dual Connectivity (MR-DC) application scenario. The terminal device or the network device can work on full duplex, flexible duplex and cross division duplex modes.

The embodiments of the present disclosure may be performed in test equipment, e.g., signal generator, signal analyzer, spectrum analyzer, network analyzer, test terminal device, test network device, or channel emulator.

The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory(ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

As used herein, the singular forms “a”, “an” and “the” are intended to include the plural forms as well, unless the context clearly indicates otherwise. The term “includes” and its variants are to be read as open terms that mean “includes, but is not limited to.” The term “based on” is to be read as “based at least in part on.” The term “one embodiment” and “an embodiment” are to be read as “at least one embodiment.” The term “another embodiment” is to be read as “at least one other embodiment.” The terms “first,” “second,” and the like may refer to different or same objects. Other definitions, explicit and implicit, may be included below.

In some examples, values, procedures, or apparatus are referred to as “best,” “lowest,” “highest,” “minimum,” “maximum,” or the like. It will be appreciated that such descriptions are intended to indicate that a selection among many used functional alternatives can be made, and such selections need not be better, smaller, higher, or otherwise preferable to other selections.

As mentioned above, for a UE in RRC idle/inactive state, the periodic paging monitoring and measurement consume considerable power at UE side, which is critical for a terminal device, especially for the power limited devices such as IoT devices or wearable devices.

A low power wake up signal (LP-WUS) is proposed in NR Release 18, which may study and evaluate techniques of low power signals and low power receivers, to enable extreme low power consumption and low wake up latency.

In some cases, the UE may use discontinuous reception (DRX) in RRC idle or inactive state in order to reduce power consumption. The UE may monitor one paging occasion (PO) per DRX cycle. A PO can consist of multiple time slots, e.g., sub-frame or orthogonal frequency divided multiple (OFDM) symbol. A PO may refer to a set of physical downlink control channel (PDCCH) monitoring occasions, such as a set of S×X consecutive PDCCH monitoring occasions, where S is the number of actual transmitted synchronization signal blocks (SSB) determined according to ssb-PositionsInBurst in system information block 1 (SIB1), and X is the nrofPDCCH-MonitoringOccasionPerSSB-InPO if configured or is equal to 1 otherwise. The [x×S+K]th PDCCH monitoring occasion for paging in the PO may correspond to the Kth transmitted SSB, where x=0, 1, . . . , X−1, and K=1, 2, . . . , S. Paging downlink control information (DCI) can be sent in the PO. One paging frame (PF) may refer to one radio frame and may contain one or multiple PO(s) or starting point of a PO.

It is up to UE implementation which SSB is selected for the determination of the PDCCH monitoring occasion in a PO. Practically, the UE may determine the SSB based on measurement result of a SSB burst, UE may choose a SSB with best quality.

In some cases, the UE may use paging early indication (PEI) in RRC idle or inactive state in order to reduce power consumption. The UE may monitor one PEI occasion per DRX cycle. A PEI occasion (PEI-O) is a set of PDCCH monitoring occasions and can consist of multiple time slots (e.g. sub-frames or OFDM symbols) where PEI can be sent. In multi-beam operations, the UE assumes that the same PEI is repeated in all transmitted beams and thus the selection of the beam(s) for the reception of the PEI is up to UE implementation.

A PEI occasion is a set of S*X consecutive PDCCH monitoring occasions, where S is the number of actual transmitted SSBs determined according to ssb-PositionsInBurst in SIB1, and X is the nrofPDCCH-MonitoringOccasionPerSSB-InPO if configured or is equal to 1 otherwise. The [x*S+K]th PDCCH monitoring occasion for PEI in the PEI occasion corresponds to the Kth transmitted SSB, where x=0, 1, . . . , X−1, and K=1, 2, . . . , S. The PDCCH monitoring occasions for PEI which do not overlap with UL symbols (determined according to tdd-UL-DL-ConfigurationCommon) are sequentially numbered from zero starting from the first PDCCH monitoring occasion for PEI in the PEI-O. When the UE detects a PEI within its PEI-O, the UE is not required to monitor the subsequent monitoring occasion(s) associated with the same PEI-O.

As described in 3GPP TS 38.213, if the UE detects PEI and the PEI indicates the subgroup the UE belongs to monitor its associated PO, the UE monitors the associated PO. If the UE does not detect PEI on the monitored PEI-O or the PEI does not indicate the subgroup the UE belongs to monitor its associated PO, the UE is not required to monitor the associated PO.

Similarly, it is up to UE implementation which SSB is selected for the determination of the PDCCH monitoring occasion in a PEI-O.

It is understood that one benefit of LP-WUS is the potential low paging latency, the UE may monitor LP-WUS continually or frequently without consuming too much power, therefore it may be woke up shortly after the network device (such as a gNB) making the decision to page the UE. However, to achieve the low paging latency, overprovision of POs/PEI-Os and the associated LP-WUS signal may be needed, and the association between the LP-WUS occasion and PO/PEI-O may be needed. The term “overprovision” means the POs are provided with a very short periodicity UE may not actually need.

Embodiments of the present disclosure provide a solution of communication. In the solution, multiple target POs/PEI-Os can be determined if an LP-WUS is configured or activated, and at least one target PO/PEI-O can be determined based on an association with a wake-up occasion (WO) in which an LP-WUS is detected. Since the multiple target POs/PEI-Os may be relatively dense in time domain and the association between the WO and the PO/PEI-O is used, there is no need to wait for a long time before monitoring the PO/PEI-O, and a low latency can be achieved. Therefore, power consumption may be further reduced at the terminal device and the efficiency of the communication may be improved. Principles and implementations of the present disclosure will be described in detail below with reference to the figures.

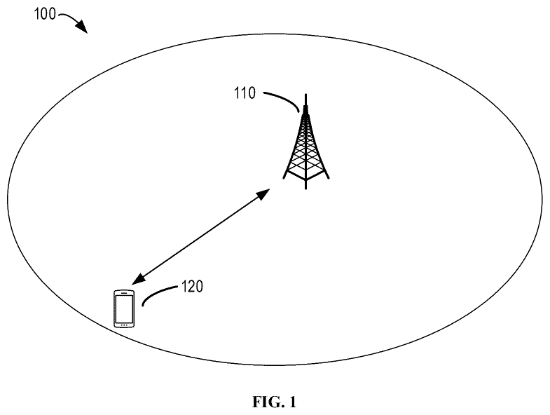

FIG. 1 illustrates an example communication system 100 in which some embodiments of the present disclosure can be implemented. The communication network 100 includes a network device 110 and a terminal device 120. The network device 110 can provide services to the terminal device 120.

In the system 100, it is assumed that the terminal device 120 is located within coverage of the network device 110. In some examples, a link from the network device 110 to the terminal device 120 is referred to as a downlink (DL), while a link from the terminal device 120 to the network device 110 is referred to as an uplink (UL). In downlink, the network device 110 is a transmitting (TX) device (or a transmitter) and the terminal device 120 is a receiving (RX) device (or a receiver). In uplink, the terminal device 120 is a transmitting TX device (or a transmitter) and the network device 110 is a RX device (or a receiver). In some embodiments, the network device 110 and the terminal device 120 may communicate with direct links/channels. DL may comprise one or more logical channels, including but not limited to a Physical Downlink Control Channel (PDCCH) and a Physical Downlink Shared Channel (PDSCH). UL may comprise one or more logical channels, including but not limited to a Physical Uplink Control Channel (PUCCH) and a Physical Uplink Shared Channel (PUSCH). As used herein, the term “channel” may refer to a carrier or a part of a carrier consisting of a contiguous set of resource blocks (RBs) on which a channel access procedure is performed in shared spectrum.

In some embodiments, the terminal device 120 may be in a main mode. In the context of the present disclose, the terms “main radio”, “main receiver” can be used interchangeably. The terminal device 120 may receive/transmit normal DL/UL transmission (e.g., PDSCH, PDCCH, PUSCH, PUCCH, etc.) in the main mode with the main radio.

In some embodiments, the terminal device 120 may be in an idle/inactive mode. For example, the same coverage as the normal DL/UL transmission cannot be provided and the terminal device 120 may receive wake up signals (WUS) with wake up receivers (WUR).

In some embodiments, the primary target for the WUS or WUR may be power-sensitive, small form-factor devices including IoT use cases (such as industrial sensors, controllers) and wearables. In some examples, low power wake up receiver architectures may be studied and evaluated. In some examples, wake up signal designs to support wake up receivers may be studied and evaluated. In some examples, L1 procedures and higher layer protocol changes needed to support the wake up signals may be studied and evaluated. In some examples, it is proposed to study potential UE power saving gains compared to the existing power saving mechanisms and their coverage availability, as well as latency impact. For example, system impact, such as network power consumption, coexistence with non-low-power-WUR UEs, network coverage/capacity/resource overhead may be included.

In some embodiments, the terminal device 120 may be in a deep sleeping mode. In the context of the present disclose, the terms “deep sleeping mode”, “ultra-deep sleeping mode”, “low power mode”, “LP mode”, “ultra-low power mode” can be used interchangeably, and the terms “low power radio”, “ultra-low power radio”, “low power receiver”, “ultra-low power receiver”, “wake-up receiver” can be used interchangeably.

In the present disclosure, the term “low power (LP) mode” may refer to a mode that the terminal device 120 is not required to perform at least one of: paging monitoring, cell selection and re-selection, measurement based on a synchronization signal block (SSB) or channel state information-reference signal (CSI-RS), PDCCH monitoring, UL transmission, etc., and the terminal device 120 is required to perform LP signal monitoring and/or detection.

In the present disclosure, the term “low power (LP) radio” may refer to a radio used in the low power mode for transmission/reception. In an embodiment, the LP radio may be independent to the main radio, and it is not used for transmission/reception of the normal DL/UL transmissions. In another embodiment, the LP radio may share at least a part of the components of the main radio, and it may have lower power consumption than the main radio.

In some embodiments, the terminal device 120 may perform, when in a main mode, at least one of: paging monitoring, cell selection and re-selection, measurement based on SSB or CSI-RS, PDCCH monitoring, or UL transmission.

In some embodiments, the terminal device 120 may enter the LP mode by switching off the main radio. For example, the terminal device 120 is allowed to switch off its main radio and switch on its LP radio, where the LP radio is used to receive the LP signals and the main radio is used to receive or transmit the signals other than the LP signals.

Communications in the system 100, between the network device 110 and the terminal device 120 for example, may be implemented according to any proper communication protocol(s), comprising, but not limited to, cellular communication protocols of the first generation (1G), the second generation (2G), the third generation (3G), the fourth generation (4G) and the fifth generation (5G) and on the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Divided Multiple Address (CDMA), Frequency Divided Multiple Address (FDMA), Time Divided Multiple Address (TDMA), Frequency Divided Duplexer (FDD), Time Divided Duplexer (TDD), Multiple-Input Multiple-Output (MIMO), Orthogonal Frequency Divided Multiple Access (OFDMA) and/or any other technologies currently known or to be developed in the future.

Embodiments of the present disclosure can be applied to any suitable scenarios. For example, embodiments of the present disclosure can be implemented at reduced capability NR devices. Alternatively, embodiments of the present disclosure can be implemented in one of the followings: NR multiple-input and multiple-output (MIMO), NR sidelink enhancements, NR systems with frequency above 52.6 GHz, an extending NR operation up to 71 GHz, narrow band-Internet of Thing (NB-IoT)/ enhanced Machine Type Communication (eMTC) over non-terrestrial networks (NTN), NTN, UE power saving enhancements, NR coverage enhancement, NB-IoT and LTE-MTC, Integrated Access and Backhaul (IAB), NR Multicast and Broadcast Services, or enhancements on Multi-Radio Dual-Connectivity.

It is to be understood that the numbers of devices (i.e., the network device 110 and the terminal device 120) and their connection relationships and types shown in FIG. 1 are only for the purpose of illustration without suggesting any limitation. The system 100 may include any suitable numbers of devices adapted for implementing embodiments of the present disclosure.

In some example embodiments, the terminal device 120, when in a low power mode, may receive a low power signal, such as an LP-WUS. In some embodiments, the LP-WUS may be used for indicating the terminal device 120 to wake up from the LP mode, and start to monitor a paging occasion for paging DCI.

In some embodiments, the LP-WUS may be based on at least one amplitude modulation sequence, where the sequence may include a symbol with higher amplitude and a symbol with lower amplitude. In some examples, the amplitude modulation may include amplitude shift keying (ASK) or on-off keying (OOK) modulation. Specifically, on-off keying (OOK) modulation is widely considered due to its very simple receiver architecture and ultra-low power consumption. With OOK modulation, the receiver may detect envelop or energy of the time domain signal with a relatively low sampling rate, and without complicated baseband processing. As an example, the OOK modulation is considered in the following disclosure as one of the amplitude modulation. An OOK modulation sequence may include at least one OOK on-symbol and at least one OOK off-symbol. The present disclosure does not limit this aspect. In some other embodiments, the LP-WUS may be based on at least one Gold sequence.

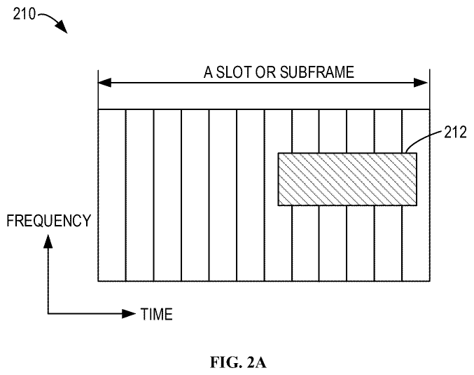

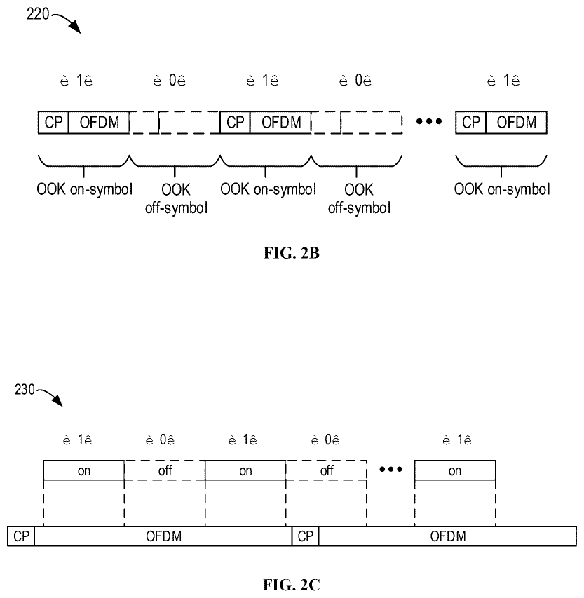

In some embodiments, the LP-WUS may occupy a set of time/frequency resources for a serving cell. FIG. 2A illustrates a schematic diagram of resources 210 occupied by an LP-WUS which can be used in some example embodiments of the present disclosure. In frequency domain, the resources allocated to the LP-WUS 212 may be overlapped with a set of PRBs or subcarriers, i.e., the terminal device 120 may be indicated a set of PRBs or subcarriers, and the frequency resources of the set of PRBs or subcarriers are used by the LP-WUS 212. In time domain, the resources allocated to the LP-WUS 212 may be overlapped with a set of OFDM symbols, i.e., the terminal device 120 may be indicated a set of OFDM symbols, and the time resources of the set of OFDM symbols are used by the LP-WUS 212.

In some examples, OOK modulation is used to generate the LP-WUS, an OOK symbol can be an OOK on-symbol (denoted by logical “1”) or an OOK off-symbol (denoted by logical “0”), where the OOK on-symbol has a relatively high power, and the OOK off-symbol has zero power or relatively low power.

It is to be understood that the OOK symbol may be equal to or may be not equal to an OFDM symbol. FIG. 2B illustrates a schematic diagram of OOK symbols 220 which can be used in some example embodiments of the present disclosure. As shown in FIG. 2B, an OOK on-symbol or an OOK off-symbol may have a duration which equals to the duration of an OFDM symbol. In this case, an OOK on-symbol and an OOK off-symbol are realized by a non-zero power OFDM symbol and a zero power OFDM symbol respectively. FIG. 2C illustrates a schematic diagram of OOK symbols 230 which can be used in some example embodiments of the present disclosure. As shown in FIG. 2C, an OOK on-symbol or an OOK off-symbol may have a duration which is shorter than an OFDM symbol. In this case, the OOK on-symbol and OOK off-symbol can be realized by DFT-s-OFDM, or by independent time domain generation.

Please note that, in the present disclosure, if not specified otherwise, the term “OFDM symbol” indicates CP-OFDM symbol, or any variant of OFDM symbol, e.g., GI-OFDM, zero CP OFDM, unique word OFDM, etc.

In some embodiments, an LP-WUS may include a sequence of OOK symbols which is formed by at least one OOK on-symbol and at least one OOK off-symbol, e.g., “1010 . . . 1” as shown in FIGS. 2B-2C. In some embodiments, the OOK on-symbol has a higher power, and the OOK off-symbol has a lower power. In the context of the present disclose, the terms “power”, “energy”, “amplitude”, “strength” may be used interchangeably.

In an RRC idle/inactive state, the terminal device 120 may get into the deep sleeping mode (i.e., stop most transmission and reception) and monitor LP-WUS signal by a wake-up radio (WUR). The terminal device 120 may wake-up from the deep sleeping mode if a positive LP-WUS is detected. Based on the different wake-up signal design, there may be three cases for the definition of positive LP-WUS:
Case 1: a single LP-WUS is used, the terminal device 120 determines whether to wake-up based on the presence of the single LP-WUS, i.e., the terminal device 120 should wake-up if the LP-WUS is detected and the terminal device 120 should not wake-up if the LP-WUS is not detected. Then, the “positive LP-WUS” may refer to the single LP-WUS.
Case 2: two LP-WUS are used, then the positive LP-WUS is the LP-WUS which is used to indicate the terminal device 120 to wake-up, and the negative LP-WUS is the LP-WUS which is used to indicate the terminal device 120 to not wake-up. The terminal device 120 should wake-up if it detects the positive LP-WUS, and not wake-up if it detects the negative LP-WUS.
Case 3: an LP-WUS which carries a wake-up indication is used, and the wake-up indication may be able to indicate the terminal device 120 to wake-up or to not wake-up (e.g., by a value “1” or “0”, or by whether its identity is carried in the indication). Then the positive LP-WUS refers to the LP-WUS with the wake-up indication which indicates the terminal device 120 to wake-up, and the negative LP-WUS refers to single LP-WUS with the wake-up indication which indicates the terminal device 120 to not wake-up.

In the present disclosure, a term “wake-up occasion (WO)” may be defined as a time duration which comprises at least one monitoring occasion for the LP-WUS. The monitoring occasion for the LP-WUS may be a time duration during which an LP-WUS can be transmitted. In some examples, the start time of the potential LP-WUS transmission is known to the terminal device 120, and the terminal device 120 may only detect the LP-WUS with the predetermined start time for each monitoring occasion. In some other examples, the start time of the potential LP-WUS transmission is not known to the terminal device 120, and the terminal device 120 should blindly detect the LP-WUS with multiple attempts within the WO.

A WO may be determined based on a start time and a duration length, or may be determined based on an end time and the duration length. The duration length may be configured by the network device 110. The start time or the end time may be configured by the network device 110, or the start time or the end time may be determined by the terminal device 120 based on a time domain position of an associated PF/PO.

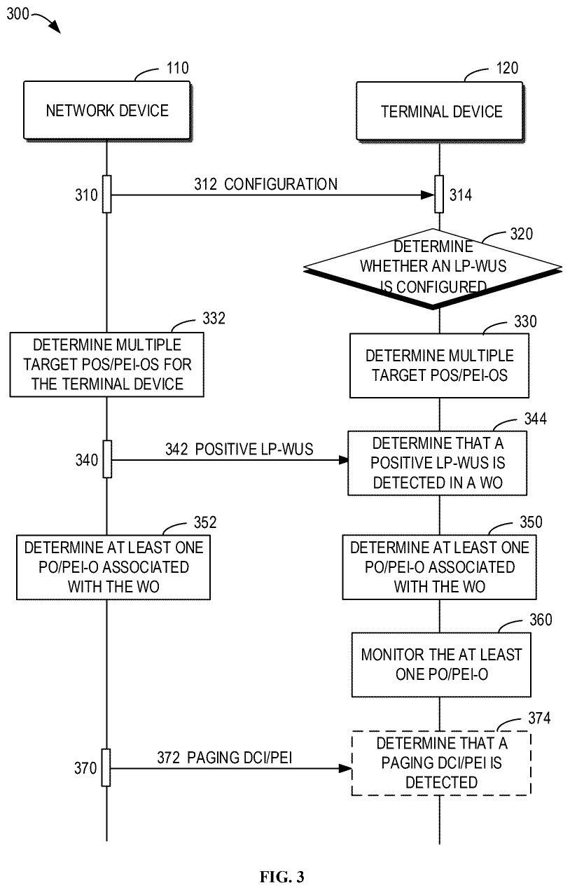

Reference is further made to FIG. 3, which illustrates a signalling chart illustrating communication process 300 in accordance with some example embodiments of the present disclosure. Only for the purpose of discussion, the process 300 will be described with reference to FIG. 1. The process 300 may involve the network device 110 and the terminal device 120.

The network device 110 transmits 310 a configuration 312 to the terminal device 120. In some example embodiments, the configuration 312 may indicate whether a low power wake up signal is configured or activated. In some example embodiments, the configuration 312 may be transmitted via an RRC message/signalling. In some example embodiments, the configuration 312 may be a paging configuration.

On the other side of communication, the terminal device 120 receive 314 the configuration 312. The terminal device 120 determines 320 whether a low power wake up signal is configured or activated based on the configuration 312.

In some embodiments, the terminal device 120 may determine at most one target PO/PEI-O if the LP-WUS is not configured or activated, and the terminal device 120 may further monitor the at most one target PO/PEI-O. In some embodiments, as shown in FIG. 3, the terminal device 120 determines 330 multiple target POs/PEI-Os in at least one DRX cycle if the LP-WUS is configured or activated.

Additionally or alternatively, the terminal device 120 may determine a set of PFs. In some example embodiments, the terminal device 120 may determine the set of PFs based on a first value set if the LP-WUS is configured or activated. In some example embodiments, the terminal device 120 may determine a PF based on an identity of the terminal device 120 if the LP-WUS is not configured or activated.

In some examples, the first value set may be a first set of values from 0 to N−1, or may be a subset of the first set of values, where N represents a total number of PFs in the at least one DRX cycle. For example, the subset of the first set of values may be configured by the network device 110, such as [0, 1, 2, 3], or [1, 2, 4, 6].

The identity of the terminal device 120 may be represented as UE_ID, and an equation may be used for PF determination. It is understood that UE_ID is used in the equation if the LP-WUS is not configured or activated, and UE_ID is not used in the equation if the LP-WUS is configured or activated.

The above various embodiments of the present disclosure may have partial impact to the current specification. The PF for paging is determined by the following formulae:
SFN for the PF is determined by:

(SFN+PF_offset)mod T=(T div N)*(UE_ID mod N), for paging configuration without LP-WUS,
or

(SFN+PF_offset) mod T=(T div N)*n, for paging configuration with LP-WUS, where n=N1, N2, . . . , Na, and (N1, N2, . . . , Na) is a subset of (0, , . . . , N−1).

Additionally or alternatively, the terminal device 120 may determine a set of indexes of a set of POs in a PF. In some example embodiments, the terminal device 120 may determine an index of a PO in the PF if the LP-WUS is not configured or activated. In some example embodiments, the terminal device 120 may determine a set of indexes of a set of POs in one of the set of PFs based on a second value set if the LP-WUS is configured or activated.

In some examples, the second value set may be a second set of values from 0 to Ns−1, or may be a subset of the second set of values, where Ns represents a total number of POs in the one of the set of PFs. For example, the subset of the second set of values may be configured by the network device 110, such as [0, 1], or [0, 1, 3].

The identity of the terminal device 120 may be represented as UE_ID, and an equation may be used for PO determination. The index of a PO may be represented as i_s, and an equation may be used for the determination of the i_s. It is understood that UE_ID is used in the equation if the LP-WUS is not configured or activated, and UE_ID is not used in the equation if the LP-WUS is configured or activated.

The above various embodiments of the present disclosure may have partial impact to the current specification. The PO for paging is determined by the following formulae:
Index (i_s), indicating the index of the PO is determined by:

i_s=floor (UE_ID/N) mod Ns, for paging configuration without LP-WUS,
or
   i_s=M1, M2, . . . , Mb, for paging configuration with LP-WUS, where (M1, M2, . . . , Mb) is a subset of (0, 1, . . . , Ns−1).

It is understood that the set (N1, N2, . . . , Na) shown above may equal to (0, 1, . . . , N−1), and the set (M1, M2, . . . , Mb) may equal to (0, 1, . . . , Ns−1) in some examples.

In some other example embodiments, the terminal device 120 may determine the set of PFs based on a sum of the identity of the terminal device 120 and the first value set if the LP-WUS is configured or activated. In some example embodiments, the terminal device 120 may determine a PF based on an identity of the terminal device 120 if the LP-WUS is not configured or activated.

The identity of the terminal device 120 may be represented as UE_ID_temp, for example, UE_ID_temp equals (5G-S-TMSI mod 1024) or (5G-S-TMSI mod 4096), and an equation may be used for PF determination: (SFN+PF_offset) mod T=(T div N)*(UE_ID mod N). The UE_ID in this equation is UE_ID_temp if the LP-WUS is not configured or activated. The UE_ID in this equation is UE_ID_temp+n1 if the LP-WUS is configured or activated, where n1 represents any value in the first value set.

In some examples, the first value set may be a first set of values from 0 to N−1, or may be a subset of the first set of values, where N represents a total number of PFs in the at least one DRX cycle. For example, the subset of the first set of values may be configured by the network device, such as [0, 1, 2, 3], or [1, 2, 4, 6].

Additionally or alternatively, the terminal device 120 may determine a set of indexes of a set of POs in a PF. In some example embodiments, the terminal device 120 may determine a set of indexes of a set of POs in one of the set of PFs based on a sum of the identity of the terminal device 120 and the second value set if the LP-WUS is configured or activated. In some example embodiments, the terminal device 120 may determine an index of a PO in the PF if the LP-WUS is not configured or activated.

The identity of the terminal device 120 may be represented as UE_ID_temp, for example, UE_ID_temp equals (5G-S-TMSI mod 1024) or (5G-S-TMSI mod 4096). The index of a PO may be represented as i_s, and an equation may be used for the determination of PO: i_s=floor (UE_ID/N) mod Ns. The UE_ID in this equation is UE_ID_temp if the LP-WUS is not configured or activated. The UE_ID in this equation is UE_ID_temp+n2 if the LP-WUS is configured or activated, where n2 represents any value in the second value set.

In some examples, the second value set may be a second set of values from 0 to Ns−1, or may be a subset of the second set of values, where Ns represents a total number of POs in the one of the set of PFs. For example, the subset of the second set of values may be configured by the network device, such as [0, 1], or [0, 1, 3].

As such, the equations used for PF determination and PO determination when the LP-WUS is configured/activated may be the same as the equations when the LP-WUS is not configured/activated, where the UE_ID in the equations can be modified to have multiple values when the LP-WUS is configured/activated. Therefore, the modification to the current specification can be minimized and overhead at the network device 110 may be reduced.

In some embodiments, the first set of values or the second set of values or the both may be preconfigured by the network device 110, or may be predefined in the specification, the present disclosure does not limit this aspect.

In some example embodiments, the terminal device 120 may be configured with two or more different DRX cycles, including a first DRX cycle and a second DRX cycle. In some examples, the at least one DRX cycle used for determining the multiple target POs/PEI-Os may be multiple first DRX cycles or may be the second DRX cycle.

Additionally or alternatively, the network device 110 may transmit a first paging configuration of the first DRX cycle and a second paging configuration of the second DRX cycle to the terminal device 120, accordingly, the terminal device 120 may receive the first paging configuration of the first DRX cycle and the second paging configuration of the second DRX cycle. In some examples, the configuration 312 may include the first paging configuration of the first DRX cycle and the second paging configuration of the second DRX cycle. In some other examples, the first paging configuration of the first DRX cycle and the second paging configuration of the second DRX cycle may be included in another message different from a message for the configuration 312. In some example embodiments, the first paging configuration may indicates a denser PO/PEI-O than the second paging configuration.

In some example embodiments, the first paging configuration of the first DRX cycle is valid if the LP-WUS is configured or activated, or if a dense PO/PEI-O is configured or activated. In some examples, the first paging configuration of the first DRX cycle may be used for determining the multiple target POs/PEI-Os or WOs.

In some example embodiments, the second paging configuration of the second DRX cycle is valid if the LP-WUS is not configured or activated, or if the dense PO/PEI-O is not configured or activated. In some examples, the second paging configuration of the second DRX cycle may be used for determining the one target PO/PEI-O or the LP-WUS monitoring occasions. In some other example embodiments, the second paging configuration of the second DRX cycle is valid regardless of whether the LP-WUS is configured or activated, or regardless of whether the dense PO/PEI-O is configured or activated.

When the LP-WUS is configured or activated or the dense PO/PEI-O is configured or activated, the terminal device 120 may determine the multiple target POs/PEI-Os based on the first paging configuration of the first DRX cycle if only the first paging configuration is valid, or the terminal device 120 may determine the multiple target POs/PEI-Os based on the first paging configuration of the first DRX cycle and the second paging configuration of the second DRX cycle if both the first paging configuration and the second paging configuration are valid. The term “valid” may mean that the terminal device 120 should monitor POs/PEI-Os based on the valid configuration.

In the present disclosure, a first length of the first DRX cycle (or be called as a first DRX cycle length) is shorter than a second length of the second DRX cycle (or be called as a second DRX cycle length). In some example embodiments, a PF or a PO/PEI-O determined based on the second paging configuration of the second DRX cycle may be overlapped with a PF or a PO/PEI-O determined based on the first paging configuration of the first DRX cycle. For example, the PFs or POs/PEI-Os determined based on the second paging configuration of the second DRX cycle may be part of PFs or POs/PEI-Os determined based on the first paging configuration of the first DRX cycle. For example, the first and second DRX cycles may have a nested structure.

In some example embodiments, the second length of the second DRX cycle may be an integer multiple of the first length of the first DRX cycle. In other words, there will be multiple first DRX cycle in a second DRX cycle. In some examples, the terminal device 120 may determine multiple target POs/PEI-Os in a second DRX cycle. In some examples, the terminal device 120 may determine multiple target POs/PEI-Os in multiple first DRX cycles, and each target PO/PEI-O is in a first DRX cycle, that is, the terminal device 120 may determine one target PO/PEI-O in each of the first DRX cycle.

The first length of the first DRX cycle can be represented as T1, the second length of the second DRX cycle can be represented as T2, a total number of PFs in the first DRX cycle can be represented as N1, and a total number of PFs in the second DRX cycle can be represented as N2. In some examples, T2 can be an integer multiple of T1, and/or T2/N2 can be an integer multiple of T1/N1. For example, T2/T1 equals to a positive integer greater than 1. For example, (T2/N2)/(T1/N1) equals to another positive integer greater than 1. In some examples, some parameters (or configurations) for the first DRX cycle and the second DRX cycle may be the same, the same parameters may include one or more of: offset used for PF determination, number of POs in a PF, positions of POs in a PF, number of POs per SSB, corset and search space configuration for paging PDCCH, etc.

In some examples, WOs are configured for the POs determined based on the first paging configuration of the first DRX cycle. In some examples, WOs may be or may be not configured for the POs of the second DRX cycles, the terminal device 120 may determine whether the WOs are configured based on the second paging configuration of the second DRX cycle. In other words, the WOs may always be configured for the first DRX cycle, and the WOs may or may not be configured for the second DRX cycle.

In some examples, the term “a second DRX cycle” may refer to a duration which starts from the start time of a system frame with a SFN, and the value of (SFN mod T2) or [(SFN+PF_offset) mod T2] equals zero, where T2 is the second length of the second DRX cycle, and PF_offset is an offset value associated with the second DRX cycle. In some examples, the duration ends at the end time of the last PO in the second DRX cycle, or ends at the start time of next second DRX cycle.

From the perspective of the network device 110, as shown in FIG. 3, the network device 110 determine 332 multiple target POs/PEI-Os in at least one DRX cycle if the LP-WUS is configured or activated for the terminal device 120. In some embodiments, the network device 119 may determine the multiple target POs/PEI-Os in at least one DRX cycle based on the configuration at the network device 110.

There may be multiple terminal devices and the terminal device 120 may be specific device in the multiple terminal devices. The network device 110 may determine multiple target POs/PEI-Os for the specific device, i.e., the terminal device 120. In some examples, the network device 110 may determine multiple target POs/PEI-Os for each of the multiple terminal devices. It is understood that the determination at 332 is similar with the determination at 330 described above, and the detailed embodiments for the determination at 332 will not be described repeat for brevity.

As shown in FIG. 3, the network device 110 transmits 340 a positive LP-WUS 342 in a WO to the terminal device 120. Additionally or alternatively, the network device 110 may determine one or more WOs associated with the multiple target POs/PEI-Os, and the network device 110 may determine (or select) one WO for transmitting the positive LP-WUS from the one or more WOs.

On the other side of communication, the terminal device 120 determines that a positive LP-WUS 342 is detected in a WO. Additionally or alternatively, the terminal device 120 may determine one or more WOs based on the multiple target POs/PEI-Os, the terminal device 120 may monitor the one or more WOs, and the terminal device 120 may determine whether a positive LP-WUS is detected in one of the one or more WOs. For example, the one or more WOs are associated with the multiple target POs/PEI-Os. Then, the terminal device 120 may determine 344 that a positive LP-WUS is detected in a WO. For example, the WO in which the positive LP-WUS is detected may be one of the one or more WOs. In some example embodiments, the terminal device 120 may skip the remaining WOs if a positive LP-WUS is detected in a WO, as such the power consumption can be further reduced.

In some example embodiments, the multiple target POs/PEI-Os may include a group of target POs/PEI-Os associated with a same WO, where the group of target POs/PEI-Os may include a single target PO/PEI-O (i.e., only one target PO/PEI-O) or the group of target POs/PEI-Os may include more than one target PO/PEI-O (i.e., at least two target POs/PEI-Os). The network device 110 or terminal device 120 may determine the same WO based on a time offset and a start time related with the group of target POS/PEI-Os.

In some examples, the start time used for determining the same WO may be a start time of the first target PO/PEI-O in the group of target POs/PEI-Os. If the group of target POs/PEI-Os includes a single target PO/PEI-O, the start time used for determining the same WO is the start time of the single target PO/PEI-O. If the group of target POs/PEI-Os includes more than one target PO/PEI-O, the start time used for determining the same WO is the start time of the first target PO/PEI-O in the group of target POs/PEI-Os.

In some examples, the time offset may be configured by the network device 110. In some other examples, the time offset may be pre-defined, such as pre-defined in the communication specification. In some other examples, the time offset may be determined based on a minimum requirement of wake up delay. For example, the time offset may be determined based on a minimum duration from a time at which the positive LP-WUS is detected to a time at which the terminal device is able to start monitoring a PO or a PEI-O, e.g., the time offset may be equal to or be larger than the minimum duration. For example, the time offset may be based on a SSB configuration. As an example, the time offset may be equal to or be larger than the time duration from a time at which the positive LP-WUS is detected to an end time of the Nth SSB burst, where N is an integer, and the terminal device 120 may perform SSB measurement based on the Nth burst.

For example, if the start time of the first target PO/PEI-O in the group of target POs/PEI-Os is t1, and the time offset is ΔT1, then the start time or the end time of the WO may be t1−ΔT1. In some examples, t1 and ΔT1 may be in unit of millisecond or second. In some examples, t1 may be an index of a symbol, a slot, or a sub-frame, and ΔT1 may be a number of symbols, slots, or sub-frames.

In some other examples, the start time may be a start time of a PF which the group of target POs/PEI-Os in. For example, the group of target POs/PEI-Os are in a PF (for example, represented as PF1), the start time of PF1 is t2, and the time offset is ΔT2, then the start time or the end time of the WO may be t2−ΔT2. In some examples, t2 and ΔT2 may be in unit of millisecond or second. In some examples, t2 may be an index of a symbol, a slot, or a sub-frame, and ΔT2 may be a number of symbols, slots, or sub-frames.

In some examples, the start time t1 and the start time t2 may be the same or be different. In some examples, the time offset ΔT1 and the time offset ΔT2 may be the same or be different.

In some example embodiments, the terminal device 120 may monitor the one or more WOs associated with the multiple target POs/PEI-Os, and the terminal device 120 may determine that a positive LP-WUS is detected in a WO. The terminal device 120 further determines 350 at least one target PO/PEI-O associated with the WO from the multiple target POs/PEI-Os. And then the terminal device 120 monitors 360 the at least one target PO/PEI-O.

In some examples, the WO in which the positive LP-WUS is detected may be associated with a single target PO/PEI-O. In some other examples, the WO in which the positive LP-WUS is detected may be associated with more than one target PO/PEI-O. In some examples, the terminal device 120 may determine a number of the at least one target PO/PEI-O associated with the WO based on a configuration from the network device 110. For example, if the network device 110 indicates that there are two POs/PEI-Os associated with the WO in which the positive LP-WUS is detected, then the terminal device 120 may determine that the at least one target PO/PEI-O includes two consecutive POs/PEI-Os, and the terminal device 120 may further monitor both the two consecutive POs/PEI-Os.

In some examples, the terminal device 120 may determine the at least one target PO/PEI-O based on a time at which the positive LP-WUS is detected. The terminal device 120 may be configured with one or more WOs, if the terminal device 120 detects a positive LP-WUS in a WO, it may determine that at least one target PO/PEI-O based on the time that the terminal device 120 detects the positive LP-WUS. It can be understood that any of the multiple target POs/PEI-Os may be possible to be the at least one target PO/PEI-O.

For example, the terminal device 120 may determine the at least one target PO/PEI-O based on a start/end time of the WO and a first time offset. For example, the terminal device 120 may determine a PF based on a start/end time of the WO and a second time offset, and further determine the at least one target PO/PEI-O in the PF.

On the other side of communication, the network device 110 determines 352 at least one target PO/PEI-O associated with the WO in which the positive LP-WUS 342 is transmitted. In some examples, the WO in which the positive LP-WUS 342 is transmitted may be associated with a single target PO/PEI-O. In some other examples, the WO in which the positive LP-WUS is transmitted may be associated with more than one target PO/PEI-O. In some examples, if the network device 110 configures that there are two POs/PEI-Os associated with the WO in which the positive LP-WUS is transmitted, then the at least one target PO/PEI-O includes two consecutive POs/PEI-Os.

In some examples, the network device 110 may determine the at least one target PO/PEI-O based on a time at which the positive LP-WUS is transmitted. For example, the network device 110 may determine the at least one target PO/PEI-O based on a start/end time of the WO and a first time offset. For example, the network device 110 may determine a PF based on a start/end time of the WO and a second time offset, and further determine the at least one target PO/PEI-O in the PF.

It is understood that the determination at 352 is similar with the determination at 350 described above, and the at least one target PO/PEI-O determined by the network device 110 at 352 and by the terminal device 120 at 350 may be the same, as such the communication can be aligned at both sides, and the accuracy of the communication can be guaranteed.

The network device 110 transmits 370 a paging DCI/PEI 372 in one of the at least one target PO/PEI-O to the terminal device 120. Specifically, the network device 110 may transmit the paging DCI in one of the at least one target PO, or transmit the PEI in one of the at least one target PEI-O. In some examples, from the perspective of the network device 110, it may transmit at most one paging DCI/PEI for a specific terminal device (such as the terminal device 120) in the at least one DRX cycle (such as the second DRX cycle described above). In other words, at most one paging DCI/PEI is transmitted from the network device 110 to the terminal device 120 during a second length, the second length is a time length of the second DRX cycle described above.

On the other side of communication, the terminal device 120 may determine 374 that a paging DCI/PEI 372 is detected in one of the at least one target PO/PEI-O. In some examples, the terminal device 120 may expect to receive at most one paging DCI/PEI in the at least one target PO/PEI-O, or at most one paging message matching the identity of the terminal device 120, and the terminal device 120 may skip the remaining occasions. As such the power consumption at the terminal device 120 can be further reduced. For example, if a paging DCI is received in one of the multiple target POs, the terminal device 120 may stop monitoring the remaining target POs in the at least one DRX cycle. For example, if a PEI is received in one of the multiple target PEI-Os, the terminal device 120 may stop monitoring the remaining target PEI-Os in the at least one DRX cycle. For example, if a paging message (or a short message) matching the identity of the terminal device 120 is received in the at least one DRX cycle, the terminal device 120 may stop monitoring the remaining target POs/PEI-Os in the at least one DRX cycle.

In some examples, the terminal device 120 may stop monitoring the remaining POS/PEI-Os after successfully detecting a PDCCH with cyclic redundancy check (CRC) scrambled by paging-radio network temporary identity (P-RNTI) in a PO/PEI-O or receiving paging information which matches an identity of the terminal device 120. In some examples, the paging information may include paging scheduling information, a paging DCI, a paging message, or a short message. In some examples, the paging DCI is transmitted by a PDCCH with CRC scrambled by P-RNTI. In some examples, the paging DCI is used to schedule a PDSCH or to transmit a Short Message.

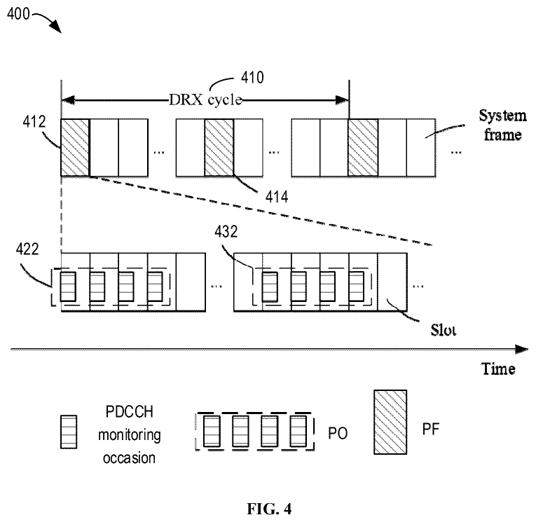

FIG. 4 illustrates a schematic diagram 400 of POs in a DRX cycle in accordance with some embodiments of the present disclosure. As shown in FIG. 4, it is assumed that there are two PFs in a DRX cycle 410 from the perspective of the network device 110. The two PFs in the DRX cycle 410 are shown as PF 412 and PF 414. Additionally, it is assumed that there are two POs (i.e., PO1 and PO2) in each of the PFs from the perspective of the network device 110. The two POs in PF 412 are shown as PO 422 and PO 432. There are totally 4 POs in the DRX cycle 410 in this example as shown in FIG. 4.

In some examples, if the LP-WUS is not configured or activated, the terminal device 120 may determine one target PO from the four POs in the DRX cycle 410, and may monitor the one target PO in the DRX cycle 410.

In some examples, if the LP-WUS is configured or activated, the terminal device 120 may determine multiple target POs from the four POs in the DRX cycle 410. For example, the terminal device 120 may determine two target POs, such as PO 422 and PO 432, or such as PO 422 and PO1 (not shown in FIG. 4) in PF 414. For a specific target PO in the multiple target POs, the terminal device 120 may determine whether to monitor the specific target PO based on whether a positive LP-WUS associated with the specific target PO is detected. In the case that the terminal device 120 determines two target POs, it may then determine whether to monitor the two target POs based on whether a positive LP-WUS is detected in associated two WOs respectively.

It is understood that some examples are shown in FIG. 4 only for the purpose of illustration without suggesting any limitation as to the scope of the disclosure, some other examples may also be applied and the present disclosure does not list herein for brevity.

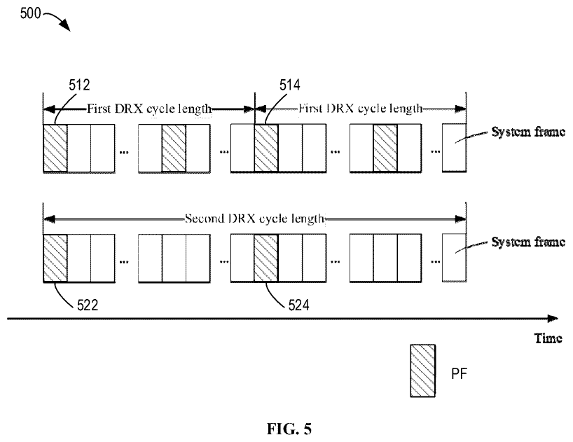

FIG. 5 illustrates a schematic diagram 500 of the first DRX cycle and the second DRX cycle in accordance with some embodiments of the present disclosure. As shown in FIG. 5, the second DRX cycle length may be two times of the first DRX cycle length. As shown in FIG. 5, the PFs determined based on the second DRX cycle (i.e., PF 522 and PF 524) is overlapped with that determined based on the first DRX cycle (i.e., PF 512 and PF 514).

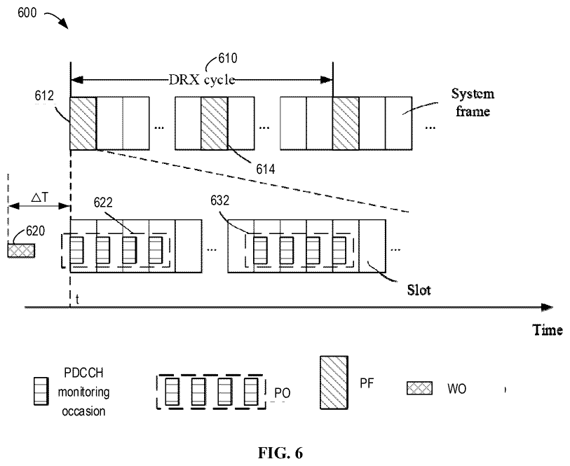

FIG. 6 illustrates a schematic diagram 600 of the association between a WO and a group of POs in accordance with some embodiments of the present disclosure. As shown in FIG. 6, the DRX cycle 610 includes PF 612 and PF 614, where PF 612 includes PO 622 and PO 632. It is assumed that the terminal device 120 determines that multiple target POs include PO 622 and PO 632, and the terminal device 120 is configured that the two POs, i.e., PO 622 and PO 632, are associated with a same WO. In some examples, the terminal device 120 may determine the WO 620 based on the start time of PO 622 (t1 described above, represented as t in FIG. 6) and a time offset (ΔT1 described above, represented as ΔT in FIG. 6). In some examples, the terminal device 120 may determine the WO based on the start time of PF 612 (t2 described above, represented as t in FIG. 6) and a time offset (ΔT2 described above, represented as ΔT in FIG. 6).

According to the example embodiments described with reference to FIGS. 3-6, based on an association of the WO and PO/PEI-O, from the perspective of the terminal device 120, if a positive LP-WUS is detected, the terminal device 120 may determine to monitor the associated at least one target PO/PEI-O; and from the perspective of the network device, the network device 110 may transmit the paging DCI/PEI in the associated at least one target PO/PEI-O. Therefore, the misunderstanding of the transmission and reception timing can be avoided. Since the association between the WO and the PO/PEI-O is used, there is no need to wait for a long time before monitoring the PO/PEI-O, and a low latency can be achieved. Therefore, power consumption at the terminal device 120 may be further reduced and the efficiency of the communication may be improved.

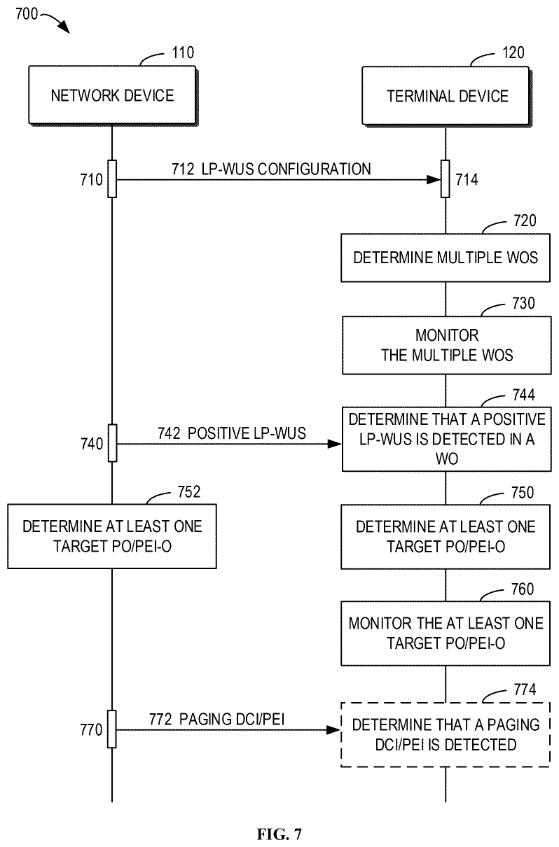

Reference is further made to FIG. 7, which illustrates a signalling chart illustrating communication process 700 in accordance with some example embodiments of the present disclosure. Only for the purpose of discussion, the process 700 will be described with reference to FIG. 1. The process 700 may involve the network device 110 and the terminal device 120.

The network device 110 transmits 710 an LP-WUS configuration 712 to the terminal device 120. The LP-WUS configuration 712 may indicate multiple WOs. On the other side of communication, the terminal device 120 receives 714 the LP-WUS configuration 712. Accordingly, the terminal device 120 determines 720 multiple WOs based on the LP-WUS configuration 712. And then the terminal device 120 monitors 730 the multiple WOs.

The network device 110 transmits 740 a positive LP-WUS 742 in a WO to the terminal device 120. Additionally or alternatively, the network device 110 may determine (or select) one WO for transmitting the positive LP-WUS from the multiple WOs. On the other side of communication, the terminal device 120 determines 744 that a positive LP-WUS 742 is detected in a WO. For example, the WO in which the positive LP-WUS 742 is detected may be one of the multiple WOs. In some example embodiments, the terminal device 120 may skip the remaining WOs if a positive LP-WUS 742 is detected in a WO, as such the power consumption can be further reduced.

The terminal device 120 determines 750 at least one target PO/PEI-O associated with the WO. Specifically, the terminal device 120 may determine the at least one target PO/PEI-O based on a time offset and a first time at which the positive LP-WUS 742 is detected. Then the terminal device 120 monitors 760 the at least one target PO/PEI-O.

In some example embodiments, the first time at which the positive LP-WUS 742 is detected may be any of: (1-1) a start time of the detected positive LP-WUS, (1-2) an end time of the detected positive LP-WUS, (1-3) a start time of the one of the multiple WOs, or (1-4) an end time of the one of the multiple WOs. In other words, the first time may be the start time or the end time of the detected positive LP-WUS, or the first time may be the start time or the end time of the WO in which the positive LP-WUS is detected.

In some example embodiments, the time offset may be configured by the network device 110. For example, the LP-WUS configuration 712 may indicate the time offset. For ease of description, the time offset may be represented as ΔT3. In some embodiments, the time offset may refer to a time duration from a first time to a second time, and it is understood that the second time may be determined based on the first time and the time offset, where the second time can be related to the at least one target PO/PEI-O. In some examples, if the first time is represented as t3, then the second time may be determined as t3+ΔT3.

In some example embodiments, the terminal device 120 may determine that a PF is started in the first system frame after the second time, and then determine the at least one target PO/PEI-O in the PF. For example, all POs/PEI-Os in the determined PF are taken as the at least one target PO/PEI-O.

In some example embodiments, the terminal device 120 may determine that the at least one target PO/PEI-O (without determining PF first) is started in the first time unit after the second time, where the first time unit may be the first a lot or the first sub-frame.

In some examples, the SFN for the PF is determined by (SFN+PF_offset) mod T=(T div N)*(UE_ID mod N) and the index of the PO is determined by i_s=floor (UE_ID/N) mod Ns, where UE_ID equals (5G-S-TMSI mod 1024) or (5G-S-TMSI mod 4096) for example, T refers to the time length of the DRX cycle, N refers to a total number of PFs in the DRX cycle, and Ns refers a total number of POs for a PF.

On the other side of communication, the network device 110 determines 752 at least one target PO/PEI-O associated with the WO in which the positive LP-WUS 742 is transmitted. In some examples, the network device 110 may determine the at least one target PO/PEI-O based on a first time at which the positive LP-WUS is transmitted and a time offset.

It is understood that the determination at 752 is similar with the determination at 750 described above, and the at least one target PO/PEI-O determined by the network device 110 at 752 and by the terminal device 120 at 750 may be the same, as such the communication can be aligned at both sides, and the accuracy of the communication can be guaranteed.

The network device 110 transmits 770 a paging DCI/PEI 772 in one of the at least one target PO/PEI-O to the terminal device 120. Specifically, the network device 110 may transmit the paging DCI in one of the at least one target PO, or transmit the PEI in one of the at least one target PEI-O. In some examples, from the perspective of the network device 110, it may transmit at most one paging DCI/PEI for a specific terminal device (such as the terminal device 120) in a DRX cycle.

On the other side of communication, the terminal device 120 may determine 774 that a paging DCI/PEI 772 is detected in one of the at least one target PO/PEI-O. In some examples, the terminal device 120 may expect to receive at most one paging DCI/PEI in the at least one target PO/PEI-O, or at most one paging message matching the identity of the terminal device 120, and the terminal device 120 may skip the remaining occasions. As such the power consumption at the terminal device 120 can be further reduced. For example, if a paging DCI is received in one target PO, the terminal device 120 may stop monitoring the remaining target POs in the DRX cycle. For example, if a PEI is received in one target PEI-O, the terminal device 120 may stop monitoring the remaining target PEI-Os in the DRX cycle. For example, if a paging message (or a short message) matching the identity of the terminal device 120 is received in the DRX cycle, the terminal device 120 may stop monitoring the remaining target POs/PEI-Os in the DRX cycle.

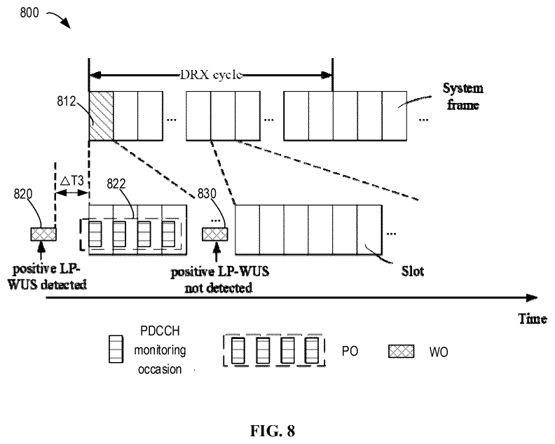

FIG. 8 illustrates a schematic diagram 800 of the association between a WO and a PO in accordance with some embodiments of the present disclosure. As shown in FIG. 8, it is assumed that the end time of the WO 820 in which the positive LP-WUS is detected is t3, and the time offset is configured as ΔT3.

In some examples, the terminal device 120 may determine that a target PO is started in the first slot after t3+ΔT3, i.e., the PO 822 shown in FIG. 8. In some other examples, the terminal device 120 may determine a PF which is started in the first system frame after t3+ΔT3, i.e., the PF 812 shown in FIG. 8, and the terminal device 120 may further determine the at least one PO in the PF, such as the PO 822 in the PF 812.

In some other examples, if there is no positive LP-WUS is detected in the WO 830, there is no need to determine the PF or PO associated with the WO 830. As such, the processing at the terminal device 120 may be simplified, and the power consumption may be reduced.

According to the example embodiments described with reference to FIGS. 7-8, a mechanism to determine the at least one target PO/PEI-O based on the detected positive LP-WUS is introduced. In this case, it may assume that the time domain positions of POS/PEI-Os (or PFs) are not configured to the terminal device, and the positions of POS/PEI-Os (or PFs) are flexible which depend on whether and when a positive LP-WUS is detected, therefore it is beneficial for the paging latency.

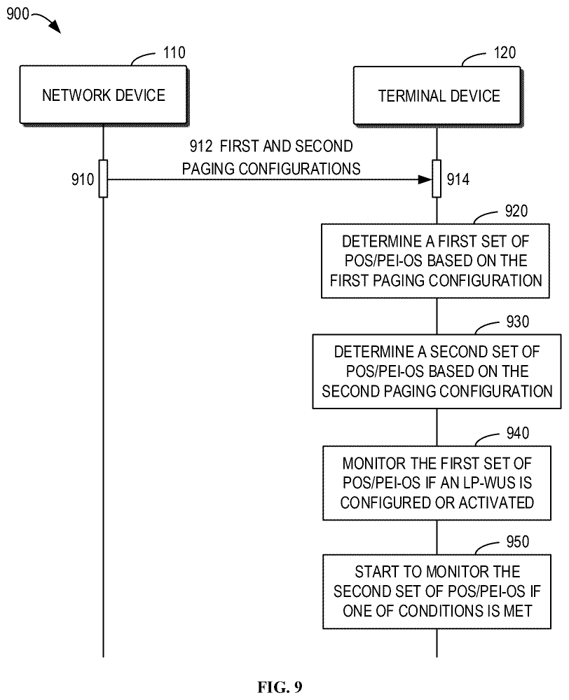

Reference is further made to FIG. 9, which illustrates a signalling chart illustrating communication process 900 in accordance with some example embodiments of the present disclosure. Only for the purpose of discussion, the process 900 will be described with reference to FIG. 1. The process 900 may involve the network device 110 and the terminal device 120.

The network device 110 transmits 910 a first paging configuration and a second paging configuration 912 to the terminal device 120. Accordingly, the terminal device 120 receives 914 the first paging configuration and the second paging configuration 912. In some example embodiments, the first paging configuration and the second paging configuration may be carried in a same message, or in different messages, the present disclosure does not limit this aspect.

The terminal device 120 determines 920 a first set of POs/PEI-Os based on the first paging configuration, and the terminal device 120 determines 930 a second set of POs/PEI-Os based on the second paging configuration. In some example embodiments, the first paging configuration may indicate a denser PO/PEI-O than the second paging configuration. In some examples, the first paging configuration may indicate a first set of POs/PEI-Os, the second paging configuration may indicate a second set of POs/PEI-Os, and the first set of POs/PEI-Os is denser than the second set of POs/PEI-Os.

In some example embodiments, the fist paging configuration may indicate a first set of PFs, and the second paging configuration may indicate a second set of PFs. The terminal device 120 may determine the first set of PFs based on the first paging configuration, and further determine the first set of POs/PEI-Os based on the first set of PFs. The terminal device 120 may determine the second set of PFs based on the second paging configuration, and further determine the second set of POs/PEI-Os based on the second set of PFs.

In some example embodiments, the first paging configuration is associated with an LP-WUS, and the second paging configuration is not associated with the LP-WUS. In some examples, if the LP-WUS is configured to the terminal device 120, then the terminal device 120 is only required to monitor the first set of POs/PEI-Os.

In some example embodiments, the first set of POs/PEI-Os and the second set of POS/PEI-Os may include one or more overlapped POs/PEI-Os. For example, the second set of POs/PEI-Os may be a subset of the first set of POs/PEI-Os. For example, all the POS/PEI-Os in the second set of POs/PEI-Os are included in the first set of POs/PEI-Os.

In some example embodiments, the first paging configuration may indicate a first DRX cycle with a first length, the second paging configuration may indicate a second DRX cycle with a second length, and the first length is shorter than the second length. In some example embodiments, the terminal device 120 may determine the first set of POs/PEI-Os in the first DRX cycle, and determine the second set of POs/PEI-Os in the second DRX cycle.

In some examples, the terminal device 120 may determine the first set of POS/PEI-Os based on the first length of the first DRX cycle, and determine the second set of POs/PEI-Os based on the second length of the second DRX cycle. In some examples, the terminal device 120 may determine a first set of PFs based on the first length of the first DRX cycle, and further determine the first set of POs/PEI-Os based on the first set of PFs. The terminal device 120 may determine a second set of PFs based on the second length of the second DRX cycle, and further determine the second set of POs/PEI-Os based on the second set of PFs.

In some examples, the first paging configuration of the first DRX cycle is valid if an LP-WUS is configured or activated, or if a dense PO/PEI-O is configured or activated. In some examples, the second paging configuration of the second DRX cycle is valid if the LP-WUS is not configured or activated, or if the dense PO/PEI-O is not configured or activated. In some other examples, the second paging configuration of the second DRX cycle is valid regardless of whether the LP-WUS is configured or activated, or regardless of whether the dense PO/PEI-O is configured or activated. The term “valid” may mean that the terminal device 120 should monitor POs/PEI-Os based on the valid configuration.

In some examples, the first length of the first DRX cycle (or be called as a first DRX cycle length) is shorter than the second length of the second DRX cycle (or be called as a second DRX cycle length). In some examples, a PF or a PO/PEI-O determined based on the second paging configuration of the second DRX cycle may be overlapped with a PF or a PO/PEI-O determined based on the first paging configuration of the first DRX cycle. For example, the PFs or POs/PEI-Os determined based on the second paging configuration of the second DRX cycle may be part of PFs or POs/PEI-Os determined based on the first paging configuration of the first DRX cycle. For example, the first and second DRX cycles may have a nested structure.

In some examples, the second length of the second DRX cycle may be an integer multiple of the first length of the first DRX cycle. In other words, there will be multiple first DRX cycle in a second DRX cycle. The first length of the first DRX cycle can be represented as T1, the second length of the second DRX cycle can be represented as T2, a total number of PFs in the first DRX cycle can be represented as N1, and a total number of PFs in the second DRX cycle can be represented as N2. In some examples, T2 can be an integer multiple of T1, and/or T2/N2 can be an integer multiple of T1/N1. For example, T2/T1 equals to a positive integer greater than 1. For example, (T2/N2)/(T1/N1) equals to another positive integer greater than 1. In some examples, some parameters (or configurations) for the first DRX cycle and the second DRX cycle may be the same, the same parameters may include one or more of: offset used for PF determination, number of POs in a PF, positions of POs in a PF, number of POs per SSB, corset and search space configuration for paging PDCCH, etc.

In some examples, the term “a second DRX cycle” may refer to a duration which starts from the start time of a system frame with a SFN, and the value of (SFN mod T2) or [(SFN+PF_offset) mod T2] equals zero, where T2 is the second length of the second DRX cycle, and PF_offset is an offset value associated with the second DRX cycle. In some examples, the duration ends at the end time of the last PO in the second DRX cycle, or ends at the start time of next second DRX cycle.

In some example embodiments, the first paging configuration may indicate a first set of PFs determined based on a first value set, or based on a sum of an identity of the terminal device 120 and the first value set. In some example embodiments, the first paging configuration may further indicate a first set of indexes of the first set of POs in one of the first set of PFs determined based on a second value set, or based on a sum of the identity of the terminal device 120 and the second value set.

In some example embodiments, the second paging configuration may indicate a second set of PFs determined based on the identity of the terminal device 120. In some example embodiments, the second paging configuration may further indicate a second set of indexes of the second set of POs in one of the second set of PFs determined based on the identity, a total number of the second set of PFs in a DRX cycle, and a total number of the second set of POs in the one of the second set of PFs.

In some examples, the first value set may be a first set of values from 0 to N−1, or may be a subset of the first set of values, where N represents a total number of PFs in the at least one DRX cycle. For example, the subset of the first set of values may be configured by the network device 110, such as [0, 1, 2, 3], or [1, 2, 4, 6]. In some examples, the second value set may be a second set of values from 0 to Ns−1, or may be a subset of the second set of values, where Ns represents a total number of POs in the one of the set of PFs. For example, the subset of the second set of values may be configured by the network device 110, such as [0, 1], or [0, 1, 3].

In some embodiments, the first set of values or the second set of values or the both may be preconfigured by the network device 110, or may be predefined in the specification, the present disclosure does not limit this aspect.

In some examples, the terminal device 120 may determine the first set of POS/PEI-Os based on the first set of PFs, and/or based on the first set of indexes of the first set of POs. In some examples, the terminal device 120 may determine the second set of POS/PEI-Os based on the second set of PFs, and/or based on the second set of indexes of the second set of POs.

The terminal device 120 monitors 940 the first set of POs/PEI-Os if an LP-WUS is configured or activated. And the terminal device 120 starts 950 to monitor the second set of POs/PEI-Os if one or more of the conditions are met: (a) the terminal device 120 is out of a coverage of the LP-WUS, (b) a signal quality of the LP-WUS is equal to or lower than a quality threshold, (c) a first indication indicating the terminal device 120 to start to monitor based on the second paging configuration is received from the network device 110, (d) a second indication indicating the terminal device 120 to stop monitoring based on the first paging configuration is received from the network device 110, (e) a third indication indicating the terminal device to quit a deep sleeping mode is received from the network device 110, or (f) a fourth indication indicating that the LP-WUS is deactivated is received from the network device 110.

In some examples, the terminal device 120 may determine the signal quality of a detected LP-WUS, and further determine whether the signal quality is below the quality threshold.

Additionally or alternatively, the network device 110 may transmit an indication to the terminal device 120 and accordingly the terminal device 120 may receive the indication, where the indication may be any of the first indication, the second indication, the third indication, or the fourth indication. For example, the first indication may indicate the terminal device 120 to monitor the second set of POs/PEI-Os, or to monitor based on the second paging configuration. For example, the second indication may indicate the terminal device 120 to stop monitoring the first set of POs/PEI-Os, or to stop monitoring based on the first paging configuration.

In some example embodiments, if one of the conditions (a)-(f) is met, the terminal device 120 may start monitor the second set of POs/PEI-Os and stop monitoring the first set of POs/PEI-Os. In some example embodiments, the terminal device 120 may stop monitoring the POs/PEI-Os in the first set of POs/PEI-Os but not in the second set of POS/PEI-Os.

In some example embodiments, the terminal device 120 may stop monitoring the LP-WUS. In some examples, the LP-WUS is configured and the terminal device 120 can monitor at least one WO for the LP-WUS. If the terminal device 120 determines one of the conditions (a)-(f) is met but none LP-WUS is detected, the terminal device 120 may stop monitoring the at least one WO and start to monitor the second set of POs/PEI-Os.

In some example embodiments, multiple POs/PEI-Os in the first set of POs/PEI-Os may be associated with a PO/PEI-O in the second set of POs/PEI-Os, or multiple PFs in the first set of PFs may be associated with a PF in the second set of PFs. In some examples, the terminal device 120 may only monitor the multiple PFs in the first set of PFs without monitoring the associated PF in the second set of PFs. In some examples, the terminal device 120 may monitor both the multiple PFs in the first set of PFs and the associated PF in the second set of PFs. It is up to the specific implementation of the terminal device 120 whether to monitor the both for better performance.

In some examples, multiple POs/PEI-Os in the first set of POs/PEI-Os may be located between two consecutive POs/PEI-Os in the second set of POs/PEI-Os in the time domain, and the multiple POs/PEI-Os in the first set of POs/PEI-Os may be associated with the later one of the two consecutive POs/PEI-Os in the second set of POs/PEI-Os.

In some examples, multiple PFs in the first set of PFs may be located between two consecutive PFs in the second set of PFs in the time domain, and the multiple PFs in the first set of PFs may be associated with the later one of the two consecutive PFs in the second set of PFs.

In some example embodiments, the terminal device 120 may expect same paging information in both the multiple POs/PEI-Os (or PFs) in the first set of POs/PEI-Os (or PFs) and the associated PO/PEI-O (or PF) in the second set of POs/PEI-Os (or PFs). In other example embodiments, the terminal device 120 may expect same paging information in both the multiple POs/PEI-Os (or PFs) in the first set of POs/PEI-Os (or PFs) and the associated PO/PEI-O (or PF) in the second set of POs/PEI-Os (or PFs) if paging information has been received in one of the multiple POs/PEI-Os (or PFs) in the first set of POs/PEI-Os (or PFs) and a response of the paging information has not been made before the start of the associated PO/PEI-O (or PF) in the second set of POs/PEI-Os (or PFs). In some examples, if paging information has been received in one of the multiple POs/PEI-Os (or PFs) in the first set of POs/PEI-Os (or PFs), the terminal device 120 may not monitor the associated PO/PEI-O (or PF) in the second set of POs/PEI-Os (or PFs). For example, the terminal device 120 may skip or stop monitoring the associated PO/PEI-O (or PF) in the second set of POs/PEI-Os (or PFs). Therefore, the processing at the terminal device 120 can be simplified and the power consumption can be reduced.

In some examples, the paging information may include a paging DCI in a PO, a PEI in a PEI-O, or a paging message or a short message matching the identity of the terminal device 120. In some examples, the terminal device 120 may response the paging information by performing an initial access procedure.

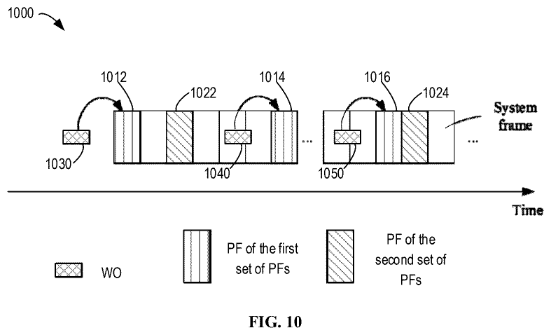

FIG. 10 illustrates a schematic diagram 1000 of the association between PFs in the first set of PFs and a PF in the second set of PFs accordance with some embodiments of the present disclosure.

As shown in FIG. 10, a first set of PFs includes PF 1012, PF 1014 and PF 1016, a second set of PFs includes PF 1022 and PF 1024. The terminal device 120 may monitor the first set of PFs if an LP-WUS is configured. For example, if an LP-WUS is detected in WO 1030, the terminal device 120 may monitor PF 1012; if an LP-WUS is detected in WO 1040, the terminal device 120 may monitor PF 1014; and if an LP-WUS is detected in WO 1050, the terminal device 120 may monitor PF 1016. In the present disclosure, the terminal device 120 monitors a PF may mean that the terminal device 120 monitors the POs/PEI-Os in the PF.

As shown in FIG. 10, PF 1014 and PF 1016 in the first set of PFs are located between PF 1022 and PF 1024 in the second set of PFs, and PF 1014 and PF 1016 are associated with PF 1024. In some examples, if one of the conditions is met before PF 1014, the terminal device 120 may not monitor PF 1014 or PF 1016, but start to monitor PF 1024.

According to the example embodiments described with reference to FIGS. 9-10, a fallback mechanism is introduced. In this case, if one of the conditions (a)-(f) described above is met, the terminal device 120 may quit from the deep sleeping mode and may get into the PO/PEI-O monitoring without an LP-WUS. Therefore, a miss detection while the terminal device 120 relies on the LP-WUS may be avoided, and the communication efficiency may be improved.

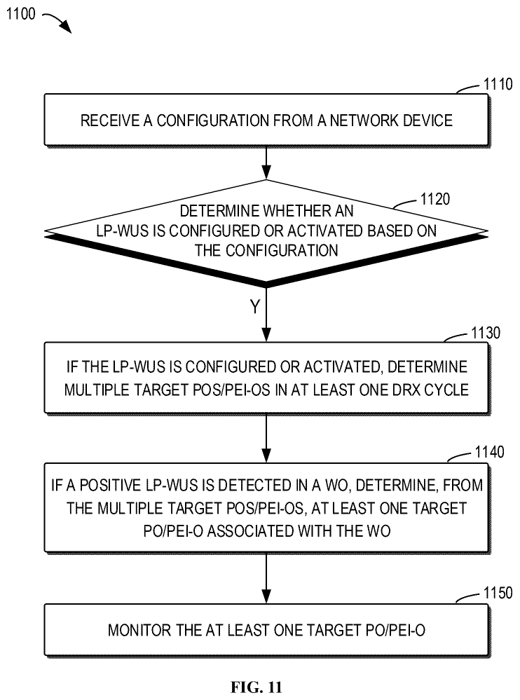

FIG. 11 illustrates a flowchart of an example method 1100 implemented at a terminal device in accordance with some embodiments of the present disclosure. For the purpose of discussion, the method 1100 will be described from the perspective of the terminal device 120 with reference to FIG. 1.

At block 1110, the terminal device 120 receives a configuration from a network device 110. At block 1120, the terminal device 120 determines whether a low power wake up signal (LP-WUS) is configured or activated based on the configuration. At block 1130, if the LP-WUS is configured or activated, the terminal device 120 determines multiple target paging occasions (POs) or paging early indication occasions (PEI-Os) in at least one discontinuous reception (DRX) cycle. At block 1140, if a positive LP-WUS is detected in a wake up occasion (WO), the terminal device 120 determines, from the multiple target POs or PEI-Os, at least one target PO or PEI-O associated with the WO. At block 1150, the terminal device 120 monitors the at least one target PO or PEI-O.

In some example embodiments, the terminal device 120 determines one or more WOs associated with the multiple target POs or PEI-Os, the one or more WOs comprises the WO; the terminal device 120monitors the one or more WOs; and the terminal device 120 determines whether the positive LP-WUS is detected in the WO.

In some example embodiments, if the multiple target POs or PEI-Os comprise a group of target POs or PEI-Os associated with a same WO, the terminal device 120 determines the same WO based on a time offset and a start time, where the start time is one of: a start time of the first target PO or PEI-O in the group of target POs or PEI-Os, or a start time of a paging frame (PF) which the group of target POs or PEI-Os in.

In some example embodiments, the time offset is configured by the network device 110, or is predefined.

In some example embodiments, the time offset is determined based on at least one of: a minimum duration from a time at which the positive LP-WUS is detected to a time at which the terminal device 120 is able to start monitoring a PO or a PEI-O, or a synchronization signal block (SSB) configuration.

In some example embodiments, the group of target POs or PEI-Os comprises: a single target PO or PEI-O, or more than one target PO or PEI-O.

In some example embodiments, the terminal device 120 determines the at least one target PO or PEI-O based on at least one of: a start time of the WO and a first time offset, or an end time of the WO and the first time offset.

In some example embodiments, the terminal device 120 determines a PF based on at least one of: a start time of the WO and a second time offset, or an end time of the WO and the second time offset; and the terminal device 120 determines the at least one target PO or PEI-O in the PF.

In some example embodiments, the terminal device 120 determines the at least one target PO or PEI-O based on a time at which the positive LP-WUS is detected.

In some example embodiments, the terminal device 120 determines a set of paging frames (PFs) based on a first value set, or a sum of an identity of the terminal device and the first value set.

In some example embodiments, the first value set is determined by: a first set of values from 0 to N−1, where N indicates a total number of PFs in the at least one DRX cycle, or a subset of the first set of values.

In some example embodiments, the terminal device 120 determines a set of indexes of a set of POs in one of the set of PFs based on a second value set, or a sum of the identity of the terminal device 120 and the second value set.

In some example embodiments, the second value set is determined by: a second set of values from 0 to Ns−1, where Ns indicates a total number of the set of POs in the one of the set of PFs, or a subset of the second set of values.

In some example embodiments, the terminal device 120 determines the multiple target POs or PEI-Os based on at least of: a first paging configuration of a first DRX cycle, or a second paging configuration of a second DRX cycle, where a first length of the first DRX cycle is shorter than a second length of the second DRX cycle, and where the at least one DRX cycle comprises multiple first DRX cycles or the second DRX cycle.

In some example embodiments, the first paging configuration of the first DRX cycle is valid based on at least one of: when the LP-WUS is configured or activated, or when a dense PO or PEI-O is configured or activated.

In some example embodiments, the second paging configuration of the second DRX cycle is valid based on at least one of: when the LP-WUS is not configured or activated, when the dense PO is not configured or activated, regardless of whether the LP-WUS is configured or activated, or regardless of whether a dense PO or PEI-O is configured or activated.

In some example embodiments, the first paging configuration of the first DRX cycle and the second paging configuration of the second DRX cycle indicate at least one of: T2 is an integer multiple of T1, T2/N2 is an integer multiple of T1/N1, offsets used for PF determination for the first DRX cycle and the second DRX cycle are the same, where T1 indicates the first time length, T2 indicates the second time length, NI indicates a total number of PFs in the first DRX cycle, and N2 indicates a total number of PFs in the second DRX cycle.

In some example embodiments, the terminal device 120 determines one target PO or PEI-O in each of the first DRX cycle.

In some example embodiments, the terminal device 120 determines multiple WOs configured for the first DRX cycle; and the terminal device 120 determines whether multiple further WOs are configured for the second DRX cycle.

In some example embodiments, if paging downlink control information (DCI) is received in one of the multiple target POs, the terminal device 120 stops monitoring remaining target POs of the multiple target POs in the at least one DRX cycle. In some example embodiments, if a paging early indication (PEI) is received in one of the multiple target PEI-Os, the terminal device 120 stops monitoring remaining target PEI-Os of the multiple target PEI-Os in the at least one DRX cycle. In some example embodiments, if a paging message matching an identity of the terminal device 120 is received in the at least one DRX cycle, the terminal device 120 stops monitoring remaining target POs or PEI-Os of the multiple target POs or PEI-Os in the at least one DRX cycle.

In some example embodiments, if the LP-WUS is not configured or activated, the terminal device 120 determines only one target PO or PEI-O in the at least one DRX cycle; and monitors the only one target PO or PEI-O.

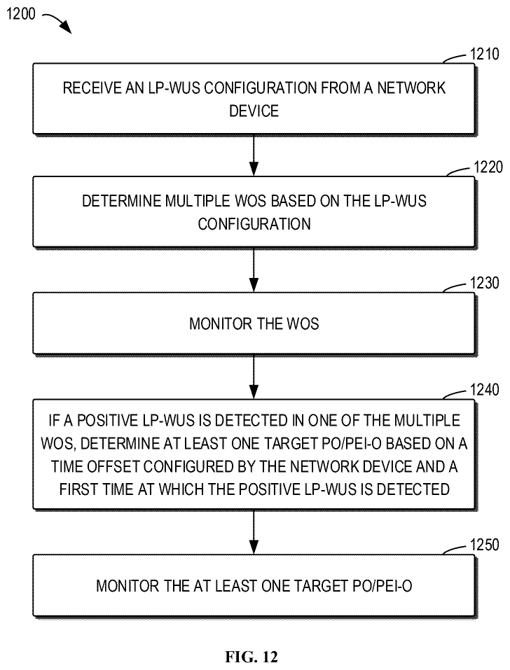

FIG. 12 illustrates a flowchart of an example method 1200 implemented at a terminal device in accordance with some embodiments of the present disclosure. For the purpose of discussion, the method 1200 will be described from the perspective of the terminal device 120 with reference to FIG. 1.

At block 1210, the terminal device 120 receives a low power wake up signal (LP-WUS) configuration from a network device 110. At block 1220, the terminal device 120 determines multiple WOs based on the LP-WUS configuration. At block 1230, the terminal device 120 monitors the WOs. At block 1240, if a positive LP-WUS is detected in one of the multiple WOs, the terminal device 120 determines at least one target paging occasion (PO) or paging early indication occasion (PEI-O) based on a time offset configured by the network device 110 and a first time at which the positive LP-WUS is detected. At block 1250, the terminal device 120 monitors the at least one target PO or PEI-O.

In some example embodiments, the first time at which the positive LP-WUS is detected comprises one or more of: a start time of the detected positive LP-WUS, an end time of the detected positive LP-WUS, a start time of the one of the multiple WOs, or an end time of the one of the multiple WOs.

In some example embodiments, the terminal device 120 determines that a paging frame (PF) is started in the first system frame after a second time determined based on the time offset from the first time to the second time; and the terminal device 120 determines the at least one target PO or PEI-O in the PF.

In some example embodiments, the terminal device 120 determines that the at least one target PO or PEI-O is started in the first time unit after a second time determined based on the time offset from the first time to the second time, where the first time unit is the first subframe or the first slot.

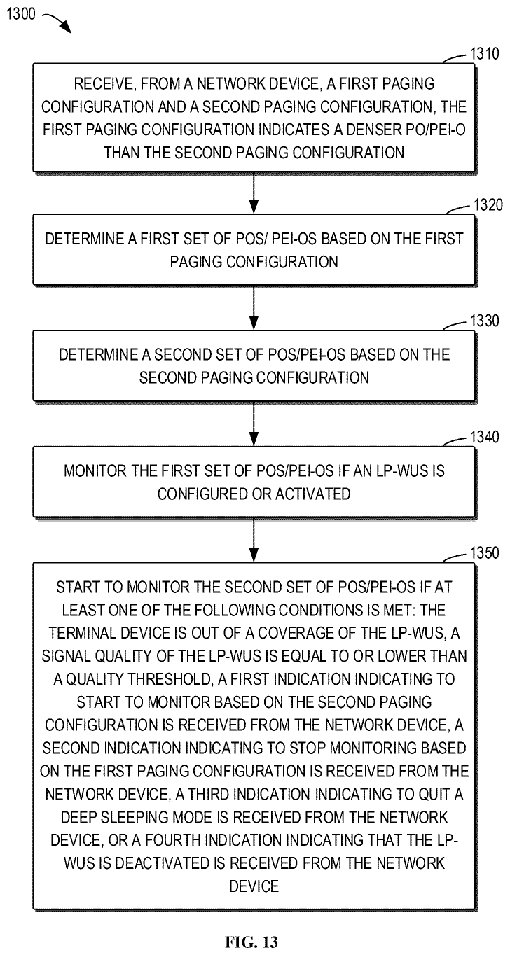

FIG. 13 illustrates a flowchart of an example method 1300 implemented at a terminal device in accordance with some embodiments of the present disclosure. For the purpose of discussion, the method 1300 will be described from the perspective of the terminal device 120 with reference to FIG. 1.

At block 1310, the terminal device 120 receives, from a network device 110, a first paging configuration and a second paging configuration, the first paging configuration indicates a denser paging occasion (PO) or paging early indication occasion (PEI-O) than the second paging configuration. At block 1320, the terminal device 120 determines a first set of POs or PEI-Os based on the first paging configuration. At block 1330, the terminal device 120 determines a second set of POs or PEI-Os based on the second paging configuration. At block 1340, if a low power wake up signal (LP-WUS) is configured or activated, the terminal device 120 monitors the first set of POs or PEI-Os. At block 1350, if at least one of the following conditions is met, the terminal device 120 starts to monitor the second set of POs or PEI-Os: the terminal device is out of a coverage of the LP-WUS, a signal quality of the LP-WUS is equal to or lower than a quality threshold, a first indication indicating the terminal device to start to monitor based on the second paging configuration is received from the network device 110, a second indication indicating the terminal device 120 to stop monitoring based on the first paging configuration is received from the network device 110, a third indication indicating the terminal device 120 to quit a deep sleeping mode is received from the network device 110, or a fourth indication indicating that the LP-WUS is deactivated is received from the network device 110.

In some example embodiments, the first paging configuration indicates a first discontinuous reception (DRX) cycle with a first length, the second paging configuration indicates a second DRX cycle with a second length, and the first length is shorter than the second length.

In some example embodiments, the first paging configuration and the second paging configuration indicate at least one of: T2 is an integer multiple of T1, T2/N2 is an integer multiple of T1/N1, offsets used for paging frame (PF) determination for the first DRX cycle and the second DRX cycle are the same, where Tl indicates the first time length, T2 indicates the second time length, NI indicates a total number of PFs in the first DRX cycle, and N2 indicates a total number of PFs in the second DRX cycle.

In some example embodiments, the first paging configuration indicates that a first set of PFs is determined based on a first value set, or a sum of an identity of the terminal device and the first value set, and the second paging configuration indicates that a second set of PFs is determined based on the identity of the terminal device.

In some example embodiments, the first value set is determined by: a first set of values from 0 to N−1, where N indicates a total number of the set of PFs in a DRX cycle, or a subset of the first set of values.

In some example embodiments, the first paging configuration further indicates that a first set of indexes of the first set of POs in one of the first set of PFs is based on a second value set, or a sum of the identity of the terminal device and the second value set, and the second paging configuration further indicates that a second set of indexes of the second set of POs in one of the second set of PFs is based on the identity, a total number of the second set of PFs in a DRX cycle, and a total number of the second set of POs in the one of the second set of PFs.

In some example embodiments, the second value set is determined by: a second set of values from 0 to Ns−1, where Ns indicates the total number of the first set of POs in the one of the first set of PFs, or a subset of the second set of values.

In some example embodiments, the first set of POs or PEI-Os comprises multiple POs or PEI-Os between two consecutive POs or PEI-Os in the second set of POs or PEI-Os, and the multiple POs or PEI-Os are associated with a latter one of the two consecutive POs or PEI-Os.

In some example embodiments, the terminal device 120 determines a first set of paging frames (PFs) based on the first paging configuration; and the terminal device 120 determines a second set of PFs based on the second paging configuration; where the first set of PFs comprises multiple PFs between two consecutive PFs in the second set of PFs, and the multiple PFs are associated with a latter one of the two consecutive PFs.

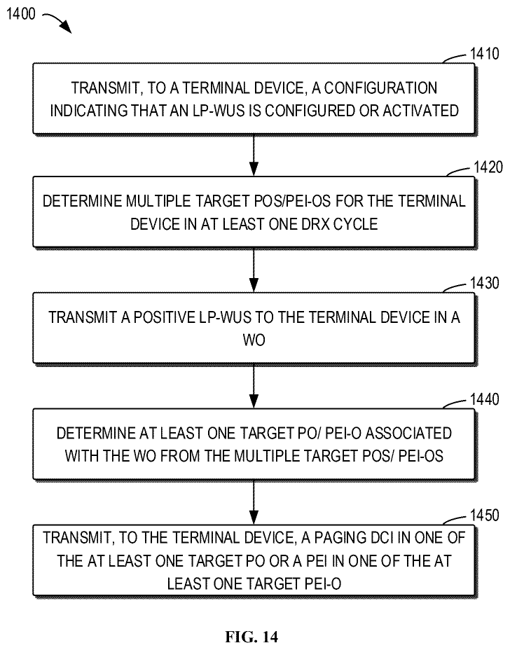

FIG. 14 illustrates a flowchart of an example method 1400 implemented at a network device in accordance with some embodiments of the present disclosure. For the purpose of discussion, the method 1400 will be described from the perspective of the network device 110 with reference to FIG. 1.

At block 1410, the network device 110 transmits, to a terminal device 120, a configuration indicating that a low power wake up signal (LP-WUS) is configured or activated. At block 1420, the network device 110 determines multiple target paging occasions (POs) or paging early indication occasions (PEI-Os) for the terminal device 120 in at least one discontinuous reception (DRX) cycle. At block 1430, the network device 110 transmits a positive LP-WUS to the terminal device 120 in a wake up occasion (WO). At block 1440, the network device 110 determines at least one target PO or PEI-O associated with the WO from the multiple target POs or PEI-Os. At block 1450, the network device 110 transmits, to the terminal device 120, paging downlink control information (DCI) in one of the at least one target PO or a paging early indication (PEI) in one of the at least one target PEI-O.

In some example embodiments, the network device 110 determines the at least one target PO or PEI-O based on at least one of: a start time of the WO and a first time offset, or an end time of the WO and the first time offset.

In some example embodiments, the network device 110 determines a paging frame (PF) based on at least one of: a start time of the WO and a second time offset, or an end time of the WO and the second time offset; and the network device 110 determines the at least one target PO or PEI-O in the PF.

In some example embodiments, the network device 110 determines one or more WOs associated with the multiple target POs or PEI-Os; and the network device 110 determines the WO for transmitting the positive LP-WUS from the one or more WOs.

In some example embodiments, if the multiple target POs or PEI-Os comprise a group of target POs or PEI-Os associated with a same WO, the network device 110 determines the same WO based on a time offset and a start time, where the start time is one of: a start time of the first target PO or PEI-O in the group of target POs or PEI-Os, or a start time of a paging frame (PF) which the group of target POs or PEI-Os in.

In some example embodiments, the time offset is predefined or is determined based on at least one of: a minimum duration from a time at which the positive LP-WUS is transmitted to a time at which the terminal device is able to start monitoring a PO or a PEI-O, or a synchronization signal block (SSB) configuration.

In some example embodiments, the group of target POs or PEI-Os comprises: a single target PO or PEI-O, or more than one target PO or PEI-O.

In some example embodiments, the network device 110 determines the multiple target POs or PEI-Os based on at least of: a first paging configuration of a first DRX cycle, or a second paging configuration of a second DRX cycle, where a first length of the first DRX cycle is shorter than a second length of the second DRX cycle, and where the at least one DRX cycle comprises multiple first DRX cycles or the second DRX cycle.

In some example embodiments, the network device 110 transmits the first paging configuration and the second paging configuration to the terminal device 120, where the first paging configuration indicates a first set of POs or PEI-Os and the second paging configuration indicates a second set of POs or PEI-Os.

In some example embodiments, the first paging configuration and the second paging configuration indicate at least one of: T2 is an integer multiple of T1, T2/N2 is an integer multiple of T1/N1, offsets used for paging frame (PF) determination for the first DRX cycle and the second DRX cycle are the same, where Tl indicates the first time length, T2 indicates the second time length, NI indicates a total number of PFs in the first DRX cycle, and N2 indicates a total number of PFs in the second DRX cycle.

In some example embodiments, the network device 110 transmits at most one paging DCI or at most one PEI to the terminal device during the second length.

In some example embodiments, the first paging configuration indicates that a first set of PFs is determined based on a first value set, or a sum of an identity of the terminal device and the first value set, and the second paging configuration indicates that a second set of PFs is determined based on the identity of the terminal device.

In some example embodiments, the first value set is determined by: a first set of values from 0 to N−1, where N indicates a total number of the first set of PFs in a DRX cycle, or a subset of the first set of values.

In some example embodiments, the first paging configuration further indicates that a first set of indexes of a first set of POs in one of the first set of PFs is based on a second value set, or a sum of the identity of the terminal device and the second value set, and the second paging configuration further indicates that a second set of indexes of a second set of POs in one of the second set of PFs is based on the identity, a total number of the second set of PFs in a DRX cycle, and a total number of the second set of POs in the one of the second set of PFs.

In some example embodiments, the second value set is determined by: a second set of values from 0 to Ns−1, where Ns indicates the total number of the first set of POs in the one of the first set of PFs, or a subset of the second set of values.

In some example embodiments, the first paging configuration is valid based on at least one of: when the LP-WUS is configured or activated, or when a dense PO or PEI-O is configured or activated.

In some example embodiments, the second paging configuration is valid based on at least one of: when the LP-WUS is not configured or activated, when the dense PO is not configured or activated, regardless of whether the LP-WUS is configured or activated, or regardless of whether a dense PO or PEI-O is configured or activated.

In some example embodiments, the network device 110 determines one target PO or PEI-O in each of the first DRX cycle.

In some example embodiments, the network device 110 transmits an indication to the terminal device, the indication indicating at least one of: the terminal device 120 to stop monitoring based on the first paging configuration, the terminal device 120 to start to monitor based on the second paging configuration, the terminal device 120 to quit a deep sleeping mode, or the LP-WUS is deactivated.

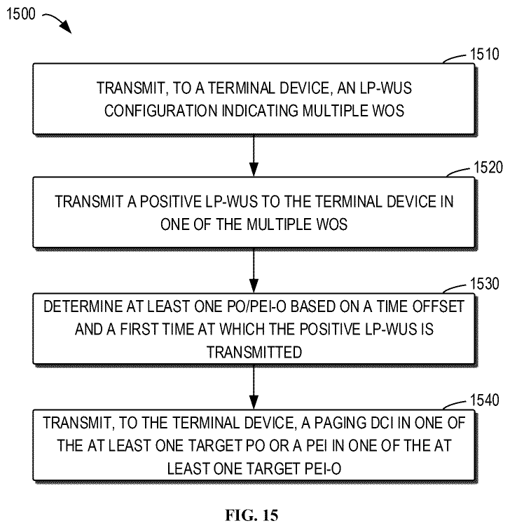

FIG. 15 illustrates a flowchart of an example method 1500 implemented at a network device in accordance with some embodiments of the present disclosure. For the purpose of discussion, the method 1500 will be described from the perspective of the network device 110 with reference to FIG. 1.

At block 1510, the network device 110 transmits, to a terminal device 120, a low power wake up signal (LP-WUS) configuration indicating multiple wake-up occasions (WOs). At block 1520, the network device 110 transmits a positive LP-WUS to the terminal device 120 in one of the multiple WOs. At block 1530, the network device 110 determines at least one target paging occasion (PO) or paging early indication occasion (PEI-O) based on a time offset and a first time at which the positive LP-WUS is transmitted. At block 1540, the network device 110 transmits, to the terminal device 120, paging downlink control information (DCI) in one of the at least one target PO or a paging early indication (PEI) in one of the at least one target PEI-O.

In some example embodiments, the first time at which the positive LP-WUS is transmitted comprises at least one of: a start time of the positive LP-WUS, an end time of the positive LP-WUS, a start time of the one of the multiple WOs, or an end time of the one of the multiple WOs.

In some example embodiments, the network device 110 determines that a paging frame (PF) is started in the first system frame after a second time determined based on the time offset from the first time to the second time; and the network device 110 determines the at least one target PO or PEI-O in the PF.

In some example embodiments, the network device 110 determines that the at least one target PO or PEI-O is started in the first time unit after a second time determined based on the time offset from the first time to the second time, where the first time unit is the first subframe or the first slot.

Details of some embodiments according to the present disclosure have been described with reference to FIGS. 1-15. Now an example implementation of the terminal device and the network device will be discussed below.

In some example embodiments, a terminal device comprises circuitry configured to: receive a configuration from a network device; determine whether a low power wake up signal (LP-WUS) is configured or activated based on the configuration; in accordance with a determination that the LP-WUS is configured or activated, determine a plurality of target paging occasions (POs) or paging early indication occasions (PEI-Os) in at least one discontinuous reception (DRX) cycle; in accordance with a determination that a positive LP-WUS is detected in a wake up occasion (WO), determine, from the plurality of target POs or PEI-Os, at least one target PO or PEI-O associated with the WO; and monitor the at least one target PO or PEI-O.

In some example embodiments, the terminal device comprises circuitry configured to: determine one or more WOs associated with the plurality of target POs or PEI-Os, the one or more WOs comprise the WO; monitor the one or more WOs; and determine whether the positive LP-WUS is detected in the WO.

In some example embodiments, the terminal device comprises circuitry configured to: in accordance with a determination that the plurality of target POs or PEI-Os comprise a group of target POs or PEI-Os associated with a same WO, determine the same WO based on a time offset and a start time, where the start time is one of: a start time of the first target PO or PEI-O in the group of target POs or PEI-Os, or a start time of a paging frame (PF) which the group of target POs or PEI-Os in.

In some example embodiments, the time offset is configured by the network device, or is predefined.

In some example embodiments, the time offset is determined based on at least one of: a minimum duration from a time at which the positive LP-WUS is detected to a time at which the terminal device is able to start monitoring a PO or a PEI-O, or a synchronization signal block (SSB) configuration.

In some example embodiments, the group of target POs or PEI-Os comprises: a single target PO or PEI-O, or more than one target PO or PEI-O.

In some example embodiments, the terminal device comprises circuitry configured to: determine the at least one target PO or PEI-O based on at least one of: a start time of the WO and a first time offset, or an end time of the WO and the first time offset.

In some example embodiments, the terminal device comprises circuitry configured to: determine a PF based on at least one of: a start time of the WO and a second time offset, or an end time of the WO and the second time offset; and determine the at least one target PO or PEI-O in the PF.

In some example embodiments, the terminal device comprises circuitry configured to: determine the at least one target PO or PEI-O based on a time at which the positive LP-WUS is detected.

In some example embodiments, the terminal device comprises circuitry configured to: determine a set of paging frames (PFs) based on a first value set, or a sum of an identity of the terminal device and the first value set.

In some example embodiments, the first value set is determined by: a first set of values from 0 to N−1, where N indicates a total number of PFs in the at least one DRX cycle, or a subset of the first set of values.

In some example embodiments, the terminal device comprises circuitry configured to: determine a set of indexes of a set of POs in one of the set of PFs based on a second value set, or a sum of the identity of the terminal device and the second value set.

In some example embodiments, the second value set is determined by: a second set of values from 0 to Ns−1, where Ns indicates a total number of the set of POs in the one of the set of PFs, or a subset of the second set of values.

In some example embodiments, the terminal device comprises circuitry configured to: determine the plurality of target POs or PEI-Os based on at least of: a first paging configuration of a first DRX cycle, or a second paging configuration of a second DRX cycle, where a first length of the first DRX cycle is shorter than a second length of the second DRX cycle, and where the at least one DRX cycle comprises a plurality of first DRX cycles or the second DRX cycle.

In some example embodiments, the first paging configuration of the first DRX cycle is valid based on at least one of: when the LP-WUS is configured or activated, or when a dense PO or PEI-O is configured or activated.

In some example embodiments, the second paging configuration of the second DRX cycle is valid based on at least one of: when the LP-WUS is not configured or activated, when the dense PO is not configured or activated, regardless of whether the LP-WUS is configured or activated, or regardless of whether a dense PO or PEI-O is configured or activated.

In some example embodiments, the first paging configuration of the first DRX cycle and the second paging configuration of the second DRX cycle indicate at least one of: T2 is an integer multiple of T1, T2/N2 is an integer multiple of T1/N1, offsets used for PF determination for the first DRX cycle and the second DRX cycle are the same, where T1 indicates the first time length, T2 indicates the second time length, N1 indicates a total number of PFs in the first DRX cycle, and N2 indicates a total number of PFs in the second DRX cycle.

In some example embodiments, the terminal device comprises circuitry configured to: determine one target PO or PEI-O in each of the first DRX cycle.

In some example embodiments, the terminal device comprises circuitry configured to: determine a plurality of WOs configured for the first DRX cycle; and determine whether a plurality of further WOs are configured for the second DRX cycle.

In some example embodiments, the terminal device comprises circuitry configured to: in accordance with a determination that paging downlink control information (DCI) is received in one of the plurality of target POs, stop monitoring remaining target POs of the plurality of target POs in the at least one DRX cycle; or in accordance with a determination that a paging early indication (PEI) is received in one of the plurality of target PEI-Os, stop monitoring remaining target PEI-Os of the plurality of target PEI-Os in the at least one DRX cycle; or in accordance with a determination that a paging message matching an identity of the terminal device is received in the at least one DRX cycle, stop monitoring remaining target POs or PEI-Os of the plurality of target POs or PEI-Os in the at least one DRX cycle.

In some example embodiments, the terminal device comprises circuitry configured to: in accordance with a determination that the LP-WUS is not configured or activated, determine only one target PO or PEI-O in the at least one DRX cycle; and monitor the only one target PO or PEI-O.

In some example embodiments, a terminal device comprises circuitry configured to: receive a low power wake up signal (LP-WUS) configuration from a network device; determine a plurality of wake-up occasions (WOs) based on the LP-WUS configuration; monitor the plurality of WOs; in accordance with a determination that a positive LP-WUS is detected in one of the plurality of WOs, determine at least one target paging occasion (PO) or paging early indication occasion (PEI-O) based on a time offset configured by the network device and a first time at which the positive LP-WUS is detected; and monitor the at least one target PO or PEI-O.

In some example embodiments, the first time at which the positive LP-WUS is detected comprises at least one of: a start time of the detected positive LP-WUS, an end time of the detected positive LP-WUS, a start time of the one of the plurality of WOs, or an end time of the one of the plurality of WOs.

In some example embodiments, the terminal device comprises circuitry configured to: determine that a paging frame (PF) is started in the first system frame after a second time determined based on the time offset from the first time to the second time; and determine the at least one target PO or PEI-O in the PF.

In some example embodiments, the terminal device comprises circuitry configured to: determine that the at least one target PO or PEI-O is started in the first time unit after a second time determined based on the time offset from the first time to the second time, where the first time unit is the first subframe or the first slot.

In some example embodiments, a terminal device comprises circuitry configured to: receive, from a network device, a first paging configuration and a second paging configuration, the first paging configuration indicating a denser paging occasion (PO) or paging early indication occasion (PEI-O) than the second paging configuration; determine a first set of POs or PEI-Os based on the first paging configuration; determine a second set of POs or PEI-Os based on the second paging configuration; in accordance with a determination that a low power wake up signal (LP-WUS) is configured or activated, monitor the first set of POs or PEI-Os; and in accordance with a determination that at least one of the following conditions is met, start to monitor the second set of POs or PEI-Os: the terminal device is out of a coverage of the LP-WUS, a signal quality of the LP-WUS is equal to or lower than a quality threshold, a first indication indicating the terminal device to start to monitor based on the second paging configuration is received from the network device, a second indication indicating the terminal device to stop monitoring based on the first paging configuration is received from the network device, a third indication indicating the terminal device to quit a deep sleeping mode is received from the network device, or a fourth indication indicating that the LP-WUS is deactivated is received from the network device.

In some example embodiments, the first paging configuration indicates a first discontinuous reception (DRX) cycle with a first length, the second paging configuration indicates a second DRX cycle with a second length, and the first length is shorter than the second length.

In some example embodiments, the first paging configuration and the second paging configuration indicate at least one of: T2 is an integer multiple of T1, T2/N2is an integer multiple of T1/N1, offsets used for paging frame (PF) determination for the first DRX cycle and the second DRX cycle are the same, where T1 indicates the first time length, T2 indicates the second time length, N1 indicates a total number of PFs in the first DRX cycle, and N2 indicates a total number of PFs in the second DRX cycle.

In some example embodiments, the first paging configuration indicates that a first set of PFs is determined based on a first value set, or a sum of an identity of the terminal device and the first value set, and the second paging configuration indicates that a second set of PFs is determined based on the identity of the terminal device.

In some example embodiments, the first value set is determined by: a first set of values from 0 to N−1, where N indicates a total number of the set of PFs in a DRX cycle, or a subset of the first set of values.

In some example embodiments, the first paging configuration further indicates that a first set of indexes of the first set of POs in one of the first set of PFs is based on a second value set, or a sum of the identity of the terminal device and the second value set, and the second paging configuration further indicates that a second set of indexes of the second set of POs in one of the second set of PFs is based on the identity, a total number of the second set of PFs in a DRX cycle, and a total number of the second set of POs in the one of the second set of PFs.

In some example embodiments, the second value set is determined by: a second set of values from 0 to Ns−1, where Ns indicates the total number of the first set of POs in the one of the first set of PFs, or a subset of the second set of values.

In some example embodiments, the first set of POs or PEI-Os comprises a plurality of POs or PEI-Os between two consecutive POs or PEI-Os in the second set of POs or PEI-Os, and the plurality of POs or PEI-Os are associated with a latter one of the two consecutive POs or PEI-Os.

In some example embodiments, the terminal device comprises circuitry configured to: determine a first set of paging frames (PFs) based on the first paging configuration; and determine a second set of PFs based on the second paging configuration; where the first set of PFs comprises a plurality of PFs between two consecutive PFs in the second set of PFs, and the plurality of PFs are associated with a latter one of the two consecutive PFs.

In some example embodiments, a network device comprises circuitry configured to: transmit, to a terminal device, a configuration indicating that a low power wake up signal (LP-WUS) is configured or activated; determine a plurality of target paging occasions (POs) or paging early indication occasions (PEI-Os) for the terminal device in at least one discontinuous reception (DRX) cycle; transmit, to the terminal device, a positive LP-WUS in a wake up occasion (WO); determine at least one target PO or PEI-O associated with the WO from the plurality of target POs or PEI-Os; and transmit, to the terminal device, paging downlink control information (DCI) in one of the at least one target PO or a paging early indication (PEI) in one of the at least one target PEI-O.

In some example embodiments, the network device comprises circuitry configured to: determine the at least one target PO or PEI-O based on at least one of: a start time of the WO and a first time offset, or an end time of the WO and the first time offset.

In some example embodiments, the network device comprises circuitry configured to: determine a paging frame (PF) based on at least one of: a start time of the WO and a second time offset, or an end time of the WO and the second time offset; and determine the at least one target PO or PEI-O in the PF.

In some example embodiments, the network device comprises circuitry configured to: determine one or more WOs associated with the plurality of target POs or PEI-Os; and determine the WO for transmitting the positive LP-WUS from the one or more WOs.

In some example embodiments, the network device comprises circuitry configured to: in accordance with a determination that the plurality of target POs or PEI-Os comprise a group of target POs or PEI-Os associated with a same WO, determine the same WO based on a time offset and a start time, where the start time is one of: a start time of the first target PO or PEI-O in the group of target POs or PEI-Os, or a start time of a paging frame (PF) which the group of target POs or PEI-Os in.

In some example embodiments, the time offset is predefined or is determined based on at least one of: a minimum duration from a time at which the positive LP-WUS is transmitted to a time at which the terminal device is able to start monitoring a PO or a PEI-O, or a synchronization signal block (SSB) configuration.

In some example embodiments, the group of target POs or PEI-Os comprises: a single target PO or PEI-O, or more than one target PO or PEI-O.

In some example embodiments, the network device comprises circuitry configured to: determine the plurality of target POs or PEI-Os based on at least of: a first paging configuration of a first DRX cycle, or a second paging configuration of a second DRX cycle, where a first length of the first DRX cycle is shorter than a second length of the second DRX cycle, and where the at least one DRX cycle comprises a plurality of first DRX cycles or the second DRX cycle.

In some example embodiments, the network device comprises circuitry configured to: transmit the first paging configuration and the second paging configuration to the terminal device, where the first paging configuration indicates a first set of POs or PEI-Os and the second paging configuration indicates a second set of POs or PEI-Os.

In some example embodiments, the first paging configuration and the second paging configuration indicate at least one of: T2 is an integer multiple of T1, T2/N2 is an integer multiple of T1/N1, offsets used for paging frame (PF) determination for the first DRX cycle and the second DRX cycle are the same, where T1 indicates the first time length, T2 indicates the second time length, N1 indicates a total number of PFs in the first DRX cycle, and N2 indicates a total number of PFs in the second DRX cycle.

In some example embodiments, the network device comprises circuitry configured to: transmit at most one paging DCI or at most one PEI to the terminal device during the second length.

In some example embodiments, the first paging configuration indicates that a first set of PFs is determined based on a first value set, or a sum of an identity of the terminal device and the first value set, and the second paging configuration indicates that a second set of PFs is determined based on the identity of the terminal device.

In some example embodiments, the first value set is determined by: a first set of values from 0 to N−1, where N indicates a total number of the first set of PFs in a DRX cycle, or a subset of the first set of values.

In some example embodiments, the first paging configuration further indicates that a first set of indexes of a first set of POs in one of the first set of PFs is based on a second value set, or a sum of the identity of the terminal device and the second value set, and the second paging configuration further indicates that a second set of indexes of a second set of POs in one of the second set of PFs is based on the identity, a total number of the second set of PFs in a DRX cycle, and a total number of the second set of POs in the one of the second set of PFs.

In some example embodiments, the second value set is determined by: a second set of values from 0 to Ns−1, where Ns indicates the total number of the first set of POs in the one of the first set of PFs, or a subset of the second set of values.

In some example embodiments, the first paging configuration is valid based on at least one of: when the LP-WUS is configured or activated, or when a dense PO or PEI-O is configured or activated.

In some example embodiments, the second paging configuration is valid based on at least one of: when the LP-WUS is not configured or activated, when the dense PO is not configured or activated, regardless of whether the LP-WUS is configured or activated, or regardless of whether a dense PO or PEI-O is configured or activated.

In some example embodiments, the network device comprises circuitry configured to: determine one target PO or PEI-O in each of the first DRX cycle.

In some example embodiments, the network device comprises circuitry configured to: transmit an indication to the terminal device, the indication indicating at least one of: the terminal device to stop monitoring based on the first paging configuration, the terminal device to start to monitor based on the second paging configuration, the terminal device to quit a deep sleeping mode, or the LP-WUS is deactivated.

In some example embodiments, a network device comprises circuitry configured to: transmit, at a network device to a terminal device, a low power wake up signal (LP-WUS) configuration indicating a plurality of wake-up occasions (WOs); transmit a positive LP-WUS to the terminal device in one of the plurality of WOs; determine at least one target paging occasion (PO) or paging early indication occasion (PEI-O) based on a time offset and a first time at which the positive LP-WUS is transmitted; and transmit, to the terminal device, paging downlink control information (DCI) in one of the at least one target PO or a paging early indication (PEI) in one of the at least one target PEI-O.

In some example embodiments, the first time at which the positive LP-WUS is transmitted comprises at least one of: a start time of the positive LP-WUS, an end time of the positive LP-WUS, a start time of the one of the plurality of WOs, or an end time of the one of the plurality of WOs.

In some example embodiments, the network device comprises circuitry configured to: determine that a paging frame (PF) is started in the first system frame after a second time determined based on the time offset from the first time to the second time; and determine the at least one target PO or PEI-O in the PF.

In some example embodiments, the network device comprises circuitry configured to: determine that the at least one target PO or PEI-O is started in the first time unit after a second time determined based on the time offset from the first time to the second time, where the first time unit is the first subframe or the first slot.

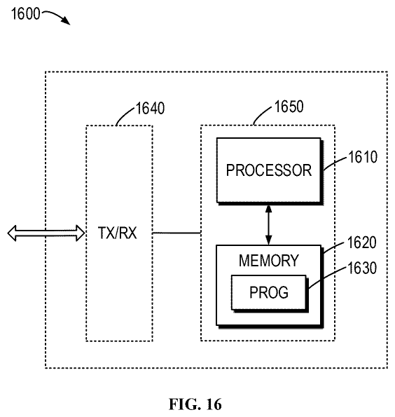

FIG. 16 illustrates a simplified block diagram of a device 1600 that is suitable for implementing embodiments of the present disclosure. The device 1600 can be considered as a further example implementation of the terminal device 120, and the network device 110 as shown in FIG. 1. Accordingly, the device 1600 can be implemented at or as at least a part of the terminal device 120, or the network device 110.

As shown, the device 1600 includes a processor 1610, a memory 1620 coupled to the processor 1610, a suitable transmitter (TX) and receiver (RX) 1640 coupled to the processor 1610, and a communication interface coupled to the TX/RX 1640. The memory 1610 stores at least a part of a program 1630. The TX/RX 1640 is for bidirectional communications. The TX/RX 1640 has at least one antenna to facilitate communication, though in practice an Access Node mentioned in this disclosure may have several ones. The communication interface may represent any interface that is necessary for communication with other network elements, such as X2 interface for bidirectional communications between eNBs, S1 interface for communication between a Mobility Management Entity (MME)/Serving Gateway (S-GW) and the eNB, Un interface for communication between the eNB and a relay node (RN), or Uu interface for communication between the eNB and a terminal device.

The program 1630 is assumed to include program instructions that, when executed by the associated processor 1610, enable the device 1600 to operate in accordance with the embodiments of the present disclosure, as discussed herein with reference to FIGS. 2-11. The embodiments herein may be implemented by computer software executable by the processor 1610 of the device 1600, or by hardware, or by a combination of software and hardware. The processor 1610 may be configured to implement various embodiments of the present disclosure. Furthermore, a combination of the processor 1610 and memory 1620 may form processing means 1650 adapted to implement various embodiments of the present disclosure.

The memory 1620 may be of any type suitable to the local technical network and may be implemented using any suitable data storage technology, such as a non-transitory computer readable storage medium, semiconductor-based memory devices, magnetic memory devices and systems, optical memory devices and systems, fixed memory and removable memory, as non-limiting examples. While only one memory 1620 is shown in the device 1600, there may be several physically distinct memory modules in the device 1600. The processor 1610 may be of any type suitable to the local technical network, and may include one or more of general purpose computers, special purpose computers, microprocessors, digital signal processors (DSPs) and processors based on multicore processor architecture, as non-limiting examples. The device 1600 may have multiple processors, such as an application specific integrated circuit chip that is slaved in time to a clock which synchronizes the main processor.

In summary, embodiments of the present disclosure may provide the following solutions.

The present disclosure provides a method of communication, comprises: receiving, at a terminal device, a configuration from a network device; determining whether a low power wake up signal (LP-WUS) is configured or activated based on the configuration; in accordance with a determination that the LP-WUS is configured or activated, determining a plurality of target paging occasions (POs) or paging early indication occasions (PEI-Os) in at least one discontinuous reception (DRX) cycle; in accordance with a determination that a positive LP-WUS is detected in a wake up occasion (WO), determining, from the plurality of target POs or PEI-Os, at least one target PO or PEI-O associated with the WO; and monitoring the at least one target PO or PEI-O.

In one embodiment, the method as above, further comprising: determining one or more WOs associated with the plurality of target POs or PEI-Os, the one or more WOs comprising the WO; monitoring the one or more WOs; and determining whether the positive LP-WUS is detected in the WO.

In one embodiment, the method as above, determining the one or more WOs comprises: in accordance with a determination that the plurality of target POs or PEI-Os comprise a group of target POs or PEI-Os associated with a same WO, determining the same WO based on a time offset and a start time, wherein the start time is one of: a start time of the first target PO or PEI-O in the group of target POs or PEI-Os, or a start time of a paging frame (PF) which the group of target POs or PEI-Os in.

In one embodiment, the method as above, the time offset is configured by the network device, or is predefined.

In one embodiment, the method as above, the time offset is determined based on at least one of: a minimum duration from a time at which the positive LP-WUS is detected to a time at which the terminal device is able to start monitoring a PO or a PEI-O, or a synchronization signal block (SSB) configuration.

In one embodiment, the method as above, the group of target POs or PEI-Os comprises: a single target PO or PEI-O, or more than one target PO or PEI-O.

In one embodiment, the method as above, determining at least one target PO or PEI-O associated with the WO comprises: determining the at least one target PO or PEI-O based on at least one of: a start time of the WO and a first time offset, or an end time of the WO and the first time offset.

In one embodiment, the method as above, determining at least one target PO or PEI-O associated with the WO comprises: determining a PF based on at least one of: a start time of the WO and a second time offset, or an end time of the WO and the second time offset; and determining the at least one target PO or PEI-O in the PF.

In one embodiment, the method as above, determining the at least one target PO or PEI-O comprises: determining the at least one target PO or PEI-O based on a time at which the positive LP-WUS is detected.

In one embodiment, the method as above, further comprising: determining a set of paging frames (PFs) based on a first value set, or a sum of an identity of the terminal device and the first value set.

In one embodiment, the method as above, the first value set is determined by: a first set of values from 0 to N−1, wherein N indicates a total number of PFs in the at least one DRX cycle, or a subset of the first set of values.

In one embodiment, the method as above, further comprising: determining a set of indexes of a set of POs in one of the set of PFs based on a second value set, or a sum of the identity of the terminal device and the second value set.

In one embodiment, the method as above, the second value set is determined by: a second set of values from 0 to Ns−1, wherein Ns indicates a total number of the set of POs in the one of the set of PFs, or a subset of the second set of values.

In one embodiment, the method as above, determining the plurality of target POs or PEI-Os in the at least one DRX cycle comprises: determining the plurality of target POs or PEI-Os based on at least of: a first paging configuration of a first DRX cycle, or a second paging configuration of a second DRX cycle, wherein a first length of the first DRX cycle is shorter than a second length of the second DRX cycle, and wherein the at least one DRX cycle comprises a plurality of first DRX cycles or the second DRX cycle.

In one embodiment, the method as above, the first paging configuration of the first DRX cycle is valid based on at least one of: when the LP-WUS is configured or activated, or when a dense PO or PEI-O is configured or activated.

In one embodiment, the method as above, the second paging configuration of the second DRX cycle is valid based on at least one of: when the LP-WUS is not configured or activated, when the dense PO is not configured or activated, regardless of whether the LP-WUS is configured or activated, or regardless of whether a dense PO or PEI-O is configured or activated.

In one embodiment, the method as above, the first paging configuration of the first DRX cycle and the second paging configuration of the second DRX cycle indicate at least one of: T2 is an integer multiple of T1, T2/N2 is an integer multiple of T1/N1, offsets used for PF determination for the first DRX cycle and the second DRX cycle are the same, wherein T1 indicates the first time length, T2 indicates the second time length, N1 indicates a total number of PFs in the first DRX cycle, and N2 indicates a total number of PFs in the second DRX cycle.

In one embodiment, the method as above, determining a plurality of target POs or PEI-Os comprises: determining one target PO or PEI-O in each of the first DRX cycle.

In one embodiment, the method as above, further comprising: determining a plurality of WOs configured for the first DRX cycle; and determining whether a plurality of further WOs are configured for the second DRX cycle.

In one embodiment, the method as above, further comprising: in accordance with a determination that paging downlink control information (DCI) is received in one of the plurality of target POs, stopping monitoring remaining target POs of the plurality of target POs in the at least one DRX cycle; or in accordance with a determination that a paging early indication (PEI) is received in one of the plurality of target PEI-Os, stopping monitoring remaining target PEI-Os of the plurality of target PEI-Os in the at least one DRX cycle; or in accordance with a determination that a paging message matching an identity of the terminal device is received in the at least one DRX cycle, stopping monitoring remaining target POs or PEI-Os of the plurality of target POs or PEI-Os in the at least one DRX cycle.

In one embodiment, the method as above, further comprising: in accordance with a determination that the LP-WUS is not configured or activated, determining only one target PO or PEI-O in the at least one DRX cycle; and monitoring the only one target PO or PEI-O.

The present disclosure provides a method of communication, comprises: receiving, at a terminal device, a low power wake up signal (LP-WUS) configuration from a network device; determining a plurality of wake-up occasions (WOs) based on the LP-WUS configuration; monitoring the plurality of WOs; in accordance with a determination that a positive LP-WUS is detected in one of the plurality of WOs, determining at least one target paging occasion (PO) or paging early indication occasion (PEI-O) based on a time offset configured by the network device and a first time at which the positive LP-WUS is detected; and monitoring the at least one target PO or PEI-O.

In one embodiment, the method as above, the first time at which the positive LP-WUS is detected comprises at least one of: a start time of the detected positive LP-WUS, an end time of the detected positive LP-WUS, a start time of the one of the plurality of WOs, or an end time of the one of the plurality of WOs.

In one embodiment, the method as above, determining the at least one target PO or PEI-O comprises: determining that a paging frame (PF) is started in the first system frame after a second time determined based on the time offset from the first time to the second time; and determining the at least one target PO or PEI-O in the PF.

In one embodiment, the method as above, determining the at least one target PO or PEI-O comprises: determining that the at least one target PO or PEI-O is started in the first time unit after a second time determined based on the time offset from the first time to the second time, wherein the first time unit is the first subframe or the first slot.

The present disclosure provides a method of communication, comprises: receiving, at a terminal device from a network device, a first paging configuration and a second paging configuration, the first paging configuration indicating a denser paging occasion (PO) or paging early indication occasion (PEI-O) than the second paging configuration; determining a first set of POs or PEI-Os based on the first paging configuration; determining a second set of POs or PEI-Os based on the second paging configuration; in accordance with a determination that a low power wake up signal (LP-WUS) is configured or activated, monitoring the first set of POs or PEI-Os; and in accordance with a determination that at least one of the following conditions is met, starting to monitor the second set of POs or PEI-Os: the terminal device is out of a coverage of the LP-WUS, a signal quality of the LP-WUS is equal to or lower than a quality threshold, a first indication indicating the terminal device to start to monitor based on the second paging configuration is received from the network device, a second indication indicating the terminal device to stop monitoring based on the first paging configuration is received from the network device, a third indication indicating the terminal device to quit a deep sleeping mode is received from the network device, or a fourth indication indicating that the LP-WUS is deactivated is received from the network device.

In one embodiment, the method as above, the first paging configuration indicates a first discontinuous reception (DRX) cycle with a first length, the second paging configuration indicates a second DRX cycle with a second length, and the first length is shorter than the second length.

In one embodiment, the method as above, the first paging configuration and the second paging configuration indicate at least one of: T2 is an integer multiple of T1, T2/N2 is an integer multiple of T1/N1, offsets used for paging frame (PF) determination for the first DRX cycle and the second DRX cycle are the same, wherein T1 indicates the first time length, T2 indicates the second time length, N1 indicates a total number of PFs in the first DRX cycle, and N2 indicates a total number of PFs in the second DRX cycle.

In one embodiment, the method as above, the first paging configuration indicates that a first set of PFs is determined based on a first value set, or a sum of an identity of the terminal device and the first value set, and the second paging configuration indicates that a second set of PFs is determined based on the identity of the terminal device.

In one embodiment, the method as above, the first value set is determined by: a first set of values from 0 to N−1, wherein N indicates a total number of the set of PFs in a DRX cycle, or a subset of the first set of values.

In one embodiment, the method as above, the first paging configuration further indicates that a first set of indexes of the first set of POs in one of the first set of PFs is based on a second value set, or a sum of the identity of the terminal device and the second value set, and the second paging configuration further indicates that a second set of indexes of the second set of POs in one of the second set of PFs is based on the identity, a total number of the second set of PFs in a DRX cycle, and a total number of the second set of POs in the one of the second set of PFs.

In one embodiment, the method as above, the second value set is determined by: a second set of values from 0 to Ns−1, wherein Ns indicates the total number of the first set of POs in the one of the first set of PFs, or a subset of the second set of values.

In one embodiment, the method as above, the first set of POs or PEI-Os comprises a plurality of POs or PEI-Os between two consecutive POs or PEI-Os in the second set of POs or PEI-Os, and the plurality of POs or PEI-Os are associated with a latter one of the two consecutive POs or PEI-Os.

In one embodiment, the method as above, further comprising: determining a first set of paging frames (PFs) based on the first paging configuration; and determining a second set of PFs based on the second paging configuration; wherein the first set of PFs comprises a plurality of PFs between two consecutive PFs in the second set of PFs, and the plurality of PFs are associated with a latter one of the two consecutive PFs.

The present disclosure provides a method of communication, comprises: transmitting, at a network device to a terminal device, a configuration indicating that a low power wake up signal (LP-WUS) is configured or activated; determining a plurality of target paging occasions (POs) or paging early indication occasions (PEI-Os) for the terminal device in at least one discontinuous reception (DRX) cycle; transmitting, to the terminal device, a positive LP-WUS in a wake up occasion (WO); determining at least one target PO or PEI-O associated with the WO from the plurality of target POs or PEI-Os; and transmitting, to the terminal device, paging downlink control information (DCI) in one of the at least one target PO or a paging early indication (PEI) in one of the at least one target PEI-O.

In one embodiment, the method as above, determining the at least one target PO or PEI-O associated with the WO comprises: determining the at least one target PO or PEI-O based on at least one of: a start time of the WO and a first time offset, or an end time of the WO and the first time offset.

In one embodiment, the method as above, determining the at least one target PO or PEI-O associated with the WO comprises: determining a paging frame (PF) based on at least one of: a start time of the WO and a second time offset, or an end time of the WO and the second time offset; and determining the at least one target PO or PEI-O in the PF.

In one embodiment, the method as above, further comprising: determining one or more WOs associated with the plurality of target POs or PEI-Os; and determining the WO for transmitting the positive LP-WUS from the one or more WOs.

In one embodiment, the method as above, determining the one or more WOs comprises: in accordance with a determination that the plurality of target POs or PEI-Os comprise a group of target POs or PEI-Os associated with a same WO, determining the same WO based on a time offset and a start time, wherein the start time is one of: a start time of the first target PO or PEI-O in the group of target POs or PEI-Os, or a start time of a paging frame (PF) which the group of target POs or PEI-Os in.

In one embodiment, the method as above, the time offset is predefined or is determined based on at least one of: a minimum duration from a time at which the positive LP-WUS is transmitted to a time at which the terminal device is able to start monitoring a PO or a PEI-O, or a synchronization signal block (SSB) configuration.

In one embodiment, the method as above, the group of target POs or PEI-Os comprises: a single target PO or PEI-O, or more than one target PO or PEI-O.

In one embodiment, the method as above, determining the plurality of target POs or PEI-Os in the at least one DRX cycle comprises: determining the plurality of target POs or PEI-Os based on at least of: a first paging configuration of a first DRX cycle, or a second paging configuration of a second DRX cycle, wherein a first length of the first DRX cycle is shorter than a second length of the second DRX cycle, and wherein the at least one DRX cycle comprises a plurality of first DRX cycles or the second DRX cycle.

In one embodiment, the method as above, further comprising: transmitting the first paging configuration and the second paging configuration to the terminal device, wherein the first paging configuration indicates a first set of POs or PEI-Os and the second paging configuration indicates a second set of POs or PEI-Os.

In one embodiment, the method as above, the first paging configuration and the second paging configuration indicate at least one of: T2 is an integer multiple of T1, T2/N2 is an integer multiple of T1/N1, offsets used for paging frame (PF) determination for the first DRX cycle and the second DRX cycle are the same, wherein T1 indicates the first time length, T2 indicates the second time length, N1 indicates a total number of PFs in the first DRX cycle, and N2 indicates a total number of PFs in the second DRX cycle.

In one embodiment, the method as above, further comprising: transmitting at most one paging DCI or at most one PEI to the terminal device during the second length.

In one embodiment, the method as above, the first paging configuration indicates that a first set of PFs is determined based on a first value set, or a sum of an identity of the terminal device and the first value set, and the second paging configuration indicates that a second set of PFs is determined based on the identity of the terminal device.

In one embodiment, the method as above, the first value set is determined by: a first set of values from 0 to N−1, wherein N indicates a total number of the first set of PFs in a DRX cycle, or a subset of the first set of values.

In one embodiment, the method as above, the first paging configuration further indicates that a first set of indexes of a first set of POs in one of the first set of PFs is based on a second value set, or a sum of the identity of the terminal device and the second value set, and the second paging configuration further indicates that a second set of indexes of a second set of POs in one of the second set of PFs is based on the identity, a total number of the second set of PFs in a DRX cycle, and a total number of the second set of POs in the one of the second set of PFs.

In one embodiment, the method as above, the second value set is determined by: a second set of values from 0 to Ns−1, wherein Ns indicates the total number of the first set of POs in the one of the first set of PFs, or a subset of the second set of values.

In one embodiment, the method as above, the first paging configuration is valid based on at least one of: when the LP-WUS is configured or activated, or when a dense PO or PEI-O is configured or activated.

In one embodiment, the method as above, the second paging configuration is valid based on at least one of: when the LP-WUS is not configured or activated, when the dense PO is not configured or activated, regardless of whether the LP-WUS is configured or activated, or regardless of whether a dense PO or PEI-O is configured or activated.

In one embodiment, the method as above, determining a plurality of target POs or PEI-Os comprises: determining one target PO or PEI-O in each of the first DRX cycle.

In one embodiment, the method as above, further comprising: transmitting an indication to the terminal device, the indication indicating at least one of: the terminal device to stop monitoring based on the first paging configuration, the terminal device to start to monitor based on the second paging configuration, the terminal device to quit a deep sleeping mode, or the LP-WUS is deactivated.

The present disclosure provides a method of communication, comprises: transmitting, at a network device to a terminal device, a low power wake up signal (LP-WUS) configuration indicating a plurality of wake-up occasions (WOs); transmitting a positive LP-WUS to the terminal device in one of the plurality of WOs; determining at least one target paging occasion (PO) or paging early indication occasion (PEI-O) based on a time offset and a first time at which the positive LP-WUS is transmitted; and transmitting, to the terminal device, paging downlink control information (DCI) in one of the at least one target PO or a paging early indication (PEI) in one of the at least one target PEI-O.

In one embodiment, the method as above, the first time at which the positive LP-WUS is transmitted comprises at least one of: a start time of the positive LP-WUS, an end time of the positive LP-WUS, a start time of the one of the plurality of WOs, or an end time of the one of the plurality of WOs.

In one embodiment, the method as above, determining the at least one target PO or PEI-O comprises: determining that a paging frame (PF) is started in the first system frame after a second time determined based on the time offset from the first time to the second time; and determining the at least one target PO or PEI-O in the PF.

In one embodiment, the method as above, determining the at least one target PO or PEI-O comprises: determining that the at least one target PO or PEI-O is started in the first time unit after a second time determined based on the time offset from the first time to the second time, wherein the first time unit is the first subframe or the first slot.

The present disclosure provides a terminal device, comprising: a processor; and a memory storing computer program codes; the memory and the computer program codes configured to, with the processor, cause the terminal device to perform the method implemented at the terminal device discussed above.

The present disclosure provides a network device, comprising: a processor; and a memory storing computer program codes; the memory and the computer program codes configured to, with the processor, cause the network device to perform the method implemented at the network device discussed above.

The present disclosure provides a computer readable medium having instructions stored thereon, the instructions, when executed by a processor of an apparatus, causing the apparatus to perform the method implemented at a terminal device or a network device discussed above.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 3-11. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

What is claimed is:

1. A method of communication, comprising:
receiving, at a terminal device, a configuration from a network device;
determining whether a low power wake up signal (LP-WUS) is configured or activated based on the configuration;
in accordance with a determination that the LP-WUS is configured or activated, determining a plurality of target paging occasions (POs) or paging early indication occasions (PEI-Os) in at least one discontinuous reception (DRX) cycle;
in accordance with a determination that a positive LP-WUS is detected in a wake up occasion (WO), determining, from the plurality of target POs or PEI-Os, at least one target PO or PEI-O associated with the WO; and
monitoring the at least one target PO or PEI-O.

2. The method of claim 1, further comprising:
determining one or more WOs associated with the plurality of target POs or PEI-Os, the one or more WOs comprising the WO;
monitoring the one or more WOs; and
determining whether the positive LP-WUS is detected in the WO.

3. The method of claim 2, wherein determining the one or more WOs comprises:
in accordance with a determination that the plurality of target POs or PEI-Os comprise a group of target POs or PEI-Os associated with a same WO, determining the same WO based on a time offset and a start time, wherein the start time is one of:
a start time of the first target PO or PEI-O in the group of target POs or PEI-Os, or
a start time of a paging frame (PF) which the group of target POs or PEI-Os in.

4. The method of claim 1, wherein determining at least one target PO or PEI-O associated with the WO comprises:
determining the at least one target PO or PEI-O based on at least one of:
a start time of the WO and a first time offset, or
an end time of the WO and the first time offset.

5. The method of claim 1, wherein determining at least one target PO or PEI-O associated with the WO comprises:
determining a PF based on at least one of:
a start time of the WO and a second time offset, or
an end time of the WO and the second time offset; and
determining the at least one target PO or PEI-O in the PF.

6. The method of claim 1, wherein determining the at least one target PO or PEI-O comprises:
determining the at least one target PO or PEI-O based on a time at which the positive LP-WUS is detected.

7. The method of claim 1, further comprising:
determining a set of paging frames (PFs) based on a first value set, or a sum of an identity of the terminal device and the first value set.

8. The method of claim 7, further comprising:
determining a set of indexes of a set of POs in one of the set of PFs based on a second value set, or a sum of the identity of the terminal device and the second value set.

9. The method of claim 1, wherein determining the plurality of target POs or PEI-Os in the at least one DRX cycle comprises:
determining the plurality of target POs or PEI-Os based on at least one of:
a first paging configuration of a first DRX cycle, or
a second paging configuration of a second DRX cycle,
wherein a first length of the first DRX cycle is shorter than a second length of the second DRX cycle, and wherein the at least one DRX cycle comprises a plurality of first DRX cycles or the second DRX cycle.

10. The method of claim 9, wherein the first paging configuration of the first DRX cycle and the second paging configuration of the second DRX cycle indicate at least one of:
T2 is an integer multiple of T1,
T2/N2 is an integer multiple of T1/N1,
offsets used for PF determination for the first DRX cycle and the second DRX cycle are the same,
wherein T1 indicates the first time length, T2 indicates the second time length, N1 indicates a total number of PFs in the first DRX cycle, and N2 indicates a total number of PFs in the second DRX cycle.

11. A method of communication, comprising:
receiving, at a terminal device, a low power wake up signal (LP-WUS) configuration from a network device;
determining a plurality of wake-up occasions (WOs) based on the LP-WUS configuration;
monitoring the plurality of WOs;
in accordance with a determination that a positive LP-WUS is detected in one of the plurality of WOs, determining at least one target paging occasion (PO) or paging early indication occasion (PEI-O) based on a time offset configured by the network device and a first time at which the positive LP-WUS is detected; and
monitoring the at least one target PO or PEI-O.

12. A method of communication, comprising:
receiving, at a terminal device from a network device, a first paging configuration and a second paging configuration, the first paging configuration indicating a denser paging occasion (PO) or paging early indication occasion (PEI-O) than the second paging configuration;
determining a first set of POs or PEI-Os based on the first paging configuration;
determining a second set of POs or PEI-Os based on the second paging configuration;
in accordance with a determination that a low power wake up signal (LP-WUS) is configured or activated, monitoring the first set of POs or PEI-Os; and
in accordance with a determination that at least one of the following conditions is met, starting to monitor the second set of POs or PEI-Os:
the terminal device is out of a coverage of the LP-WUS,
a signal quality of the LP-WUS is equal to or lower than a quality threshold,
a first indication indicating the terminal device to start to monitor based on the second paging configuration is received from the network device,
a second indication indicating the terminal device to stop monitoring based on the first paging configuration is received from the network device,
a third indication indicating the terminal device to quit a deep sleeping mode is received from the network device, or
a fourth indication indicating that the LP-WUS is deactivated is received from the network device.

13. A method of communication, comprising:
transmitting, at a network device to a terminal device, a configuration indicating that a low power wake up signal (LP-WUS) is configured or activated;
determining a plurality of target paging occasions (POs) or paging early indication occasions (PEI-Os) for the terminal device in at least one discontinuous reception (DRX) cycle;
transmitting, to the terminal device, a positive LP-WUS in a wake up occasion (WO);
determining at least one target PO or PEI-O associated with the WO from the plurality of target POs or PEI-Os; and
transmitting, to the terminal device, paging downlink control information (DCI) in one of the at least one target PO or a paging early indication (PEI) in one of the at least one target PEI-O.

14. The method of claim 13, wherein determining the at least one target PO or PEI-O associated with the WO comprises:
determining the at least one target PO or PEI-O based on at least one of:
a start time of the WO and a first time offset, or
an end time of the WO and the first time offset.

15. The method of claim 13, wherein determining the plurality of target POs or PEI-Os in the at least one DRX cycle comprises:
determining the plurality of target POs or PEI-Os based on at least one of:
a first paging configuration of a first DRX cycle, or
a second paging configuration of a second DRX cycle,
wherein a first length of the first DRX cycle is shorter than a second length of the second DRX cycle, and wherein the at least one DRX cycle comprises a plurality of first DRX cycles or the second DRX cycle.

16. The method of claim 15, further comprising:
transmitting an indication to the terminal device, the indication indicating at least one of:
the terminal device to stop monitoring based on the first paging configuration,
the terminal device to start to monitor based on the second paging configuration,
the terminal device to quit a deep sleeping mode, or
the LP-WUS is deactivated.

17. A method of communication, comprising:
transmitting, at a network device to a terminal device, a low power wake up signal (LP-WUS) configuration indicating a plurality of wake-up occasions (WOs);
transmitting a positive LP-WUS to the terminal device in one of the plurality of WOs;
determining at least one target paging occasion (PO) or paging early indication occasion (PEI-O) based on a time offset and a first time at which the positive LP-WUS is transmitted; and
transmitting, to the terminal device, paging downlink control information (DCI) in one of the at least one target PO or a paging early indication (PEI) in one of the at least one target PEI-O.

18. A terminal device comprising:
a processor; and
a memory storing computer program codes;
the memory and the computer program codes configured to, with the processor, cause the terminal device to perform the method according to any of claims 1-12.

19. A network device comprising:
a processor; and
a memory storing computer program codes;
the memory and the computer program codes configured to, with the processor, cause the network device to perform the method according to any of claims 13-17.

20. A computer readable medium having instructions stored thereon, the instructions, when executed by a processor of an apparatus, causing the apparatus to perform the method according to any of claims 1-17.
